(19) United States
(12) Patent Application Publication
(10) Pub. No.: US 2025/0314807 A1
(43) Pub. Date: Oct. 9, 2025

(54) IMAGING LENS ASSEMBLY MODULE AND ELECTRONIC DEVICE

(71) Applicant: LARGAN PRECISION CO., LTD., Taichung City (TW)

(72) Inventors: Wei-Fong HONG, Taichung City (TW); Chen-Wei FAN, Taichung City (TW)

(21) Appl. No.: 19/090,577

(22) Filed: Mar. 26, 2025

Related U.S. Application Data
(60) Provisional application No. 63/573,558, filed on Apr. 3, 2024.

(51) Int. Cl. G02B 1/118; B82Y 20/00; B82Y 30/00; G02B 1/00; H04N 23/52; H04N 23/55

(52) U.S. Cl. CPC G02B 1/118; B82Y 20/00; B82Y 30/00; G02B 1/002; H04N 23/52; H04N 23/55

(57) ABSTRACT

An imaging lens assembly module, which defines an optical axis, includes an optical element. The optical element includes a light blocking portion and an anti-reflecting thin film. The light blocking portion is opaque, and the light blocking portion is closer to the optical axis than the other portion of the optical element to the optical axis. The anti-reflecting thin film is disposed at least on a surface of the light blocking portion, and the anti-reflecting thin film includes a nano structure layer and at least one intermediate layer. The nano structure layer has a plurality of ridge-like protrusions which extends non-directionally. The intermediate layer is disposed between the nano structure layer and the optical element.

### RELATED APPLICATIONS

This application claims priority to Provisional Application Ser. No. 63/573,558, filed Apr. 3, 2024, which is herein incorporated by reference.

### BACKGROUND

### Technical Field

The present disclosure relates to an imaging lens assembly module. More particularly, the present disclosure relates to an imaging lens assembly module applicable to portable electronic devices.

### Description of Related Art

In recent years, portable electronic devices have developed rapidly. For example, intelligent electronic devices and tablets have been filled in the lives of modern people, and imaging lens assembly modules mounted on portable electronic devices have also prospered. However, as technology advances, the quality requirements of the imaging lens assembly module are becoming higher and higher. Therefore, an imaging lens assembly module, which can provide low reflectivity performance and maintain anti-reflection function, needs to be developed.

### SUMMARY

According to one aspect of the present disclosure, an imaging lens assembly module, which defines an optical axis, includes an optical element. The optical element includes a light blocking portion and an anti-reflecting thin film. The light blocking portion is opaque, and the light blocking portion is closer to the optical axis than the other portion of the optical element to the optical axis. The anti-reflecting thin film is disposed at least on a surface of the light blocking portion. The anti-reflecting thin film includes a nano structure layer and at least one intermediate layer. The nano structure layer has a plurality of ridge-like protrusions which extends non-directionally, wherein a bottom of each of the ridge-like protrusions is closer to the optical element of a top of each of the ridge-like protrusions, each of the ridge-like protrusions tapers from the bottom to the top, and an average structure height of the ridge-like protrusions is greater than 108 nm and smaller than 368 nm. The intermediate layer is disposed between the nano structure layer and the optical element. The nano structure layer is mainly made of Aluminium oxide, and the nano structure layer includes a metallic doping agent, wherein the metallic doping agent is at least distributed inside of each of the ridge-like protrusions, the metallic doping agent includes at least one of Titanium, Vanadium, Chromium, Titanium oxide, Vanadium oxide, Chromium oxide.

According to one aspect of the present disclosure, an electronic device includes the imaging lens assembly module of the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional view of an imaging lens assembly module according to the 1st embodiment of the present disclosure.

FIG. 1B is a schematic view of the imaging lens assembly module according to the 1st embodiment of FIG. 1A.

FIG. 1C is a three-dimensional view of the optical element according to the 1st embodiment of FIG. 1A.

FIG. 1D is a partial enlarged view of the optical element according to the 1st embodiment of FIG. 1C.

FIG. 1E is a schematic view of an anti-reflecting thin film and a light blocking portion according to the 1st embodiment of FIG. 1A.

FIG. 1F is a cross-sectional view from TEM of the anti-reflecting thin film and the light blocking portion according to the 1st embodiment of FIG. 1E.

FIG. 1G is an elemental map of Aluminum in the anti-reflecting thin film according to the 1st embodiment of FIG. 1F.

FIG. 1H is an elemental map of Silicon in the anti-reflecting thin film according to the 1st embodiment of FIG. 1F.

FIG. 1I is an elemental map of Titanium in the anti-reflecting thin film according to the 1st embodiment of FIG. 1F.

FIG. 2A is a three-dimensional view of an imaging lens assembly module according to the 2nd embodiment of the present disclosure.

FIG. 2B is an exploded view of the imaging lens assembly module according to the 2nd embodiment of FIG. 2A.

FIG. 2C is a schematic view of the imaging lens assembly module according to the 2nd embodiment of FIG. 2A.

FIG. 2D is a three-dimensional view of the optical element according to the 2nd embodiment of FIG. 2A.

FIG. 2E is a partial enlarged view of the optical element according to the 2nd embodiment of FIG. 2D.

FIG. 2F is a three-dimensional view of the optical elements according to the 2nd embodiment of FIG. 2A.

FIG. 2G is a partial schematic view of the optical elements according to the 2nd embodiment of FIG. 2F.

FIG. 3A is an exploded view of an imaging lens assembly module according to the 3rd embodiment of the present disclosure.

FIG. 3B is a schematic view of the imaging lens assembly module according to the 3rd embodiment of FIG. 3A.

FIG. 3C is a three-dimensional view of the optical element and the reflective element according to the 3rd embodiment of FIG. 3A.

FIG. 3D is an assembled schematic view of the optical element and the reflective element according to the 3rd embodiment of FIG. 3A.

FIG. 3E is a schematic view of the optical element according to the 3rd embodiment of FIG. 3A.

FIG. 3F is a three-dimensional view of the optical element according to the 3rd embodiment of FIG. 3A.

FIG. 3G is another three-dimensional view of the optical element according to the 3rd embodiment of FIG. 3A.

FIG. 3H is a schematic view of the optical element according to the 3rd embodiment of FIG. 3F.

FIG. 4A is a three-dimensional view of an imaging lens assembly module according to the 4th embodiment of the present disclosure.

FIG. 4B is an exploded view of the imaging lens assembly module according to the 4th embodiment of FIG. 4A.

FIG. 4C is a schematic view of the imaging lens assembly module according to the 4th embodiment of FIG. 4A.

FIG. 4D is a three-dimensional view of the optical element according to the 4th embodiment of FIG. 4A.

FIG. 4E is a schematic view of the optical element according to the 4th embodiment of FIG. 4D.

FIG. 4F is a schematic view of an anti-reflecting thin film and a light blocking portion according to the 4th embodiment of FIG. 4D.

FIG. 4G is a three-dimensional view of the optical element according to the 4th embodiment of FIG. 4A.

FIG. 4H is a schematic view of the optical element according to the 4th embodiment of FIG. 4G.

FIG. 5A is a schematic view of an imaging lens assembly module according to the 5th embodiment of the present disclosure.

FIG. 5B is a three-dimensional view of the optical element according to the 5th embodiment of FIG. 5A.

FIG. 5C is a schematic view of the optical element according to the 5th embodiment of FIG. 5A.

FIG. 6A is a schematic view of an imaging lens assembly module according to the 6th embodiment of the present disclosure.

FIG. 6B is a three-dimensional view of the optical element according to the 6th embodiment of FIG. 6A.

FIG. 6C is a schematic view of the optical element according to the 6th embodiment of FIG. 6A.

FIG. 7A is a schematic view of an imaging lens assembly module according to the 7th embodiment of the present disclosure.

FIG. 7B is a three-dimensional view of the optical element and the lens element according to the 7th embodiment of FIG. 7A.

FIG. 7C is a partial cross-sectional view of the optical element and the lens element according to the 7th embodiment of FIG. 7B.

FIG. 7D is a schematic view of the optical element and the lens element according to the 7th embodiment of FIG. 7A.

FIG. 8A is a schematic view of an electronic device according to the 8th embodiment of the present disclosure.

FIG. 8B is another schematic view of the electronic device according to the 8th embodiment in FIG. 8A.

FIG. 8C is a schematic view of an image captured by the electronic device according to the 8th embodiment in FIG. 8A.

FIG. 8D is another schematic view of an image captured by the electronic device according to the 8th embodiment in FIG. 8A.

FIG. 8E is further another schematic view of an image captured by the electronic device according to the 8th embodiment in FIG. 8A.

FIG. 9 is a schematic view of an electronic device according to the 9th embodiment of the present disclosure.

FIG. 10A is a schematic view of imaging lens assembly modules applied to a vehicle device according to the 10th embodiment of the present disclosure.

FIG. 10B is another schematic view of the imaging lens assembly modules arranged on the vehicle device according to the 10th embodiment in FIG. 10A.

FIG. 10C is further another schematic view of the imaging lens assembly modules arranged on the vehicle device according to the 10th embodiment in FIG. 10A.

### DETAILED DESCRIPTION

The present disclosure provides an imaging lens assembly module, which defines an optical axis, including an optical element. The optical element includes a light blocking portion and an anti-reflecting thin film. The light blocking portion is opaque, the light blocking portion is closer to the optical axis than the other portion of the optical element to the optical axis. The anti-reflecting thin film is disposed at least on a surface of the light blocking portion. The anti-reflecting thin film includes a nano structure layer and at least one intermediate layer. The nano structure layer has a plurality of ridge-like protrusions which extends non-directionally, wherein a bottom of each of the ridge-like protrusions is closer to the optical element of a top of each of the ridge-like protrusions, each of the ridge-like protrusions tapers from the bottom to the top, and an average structure height of the ridge-like protrusions is greater than 108 nm and smaller than 368 nm. The intermediate layer is disposed between the nano structure layer and the optical element. The nano structure layer is mainly made of Aluminium oxide, and the nano structure layer includes a metallic doping agent, wherein the metallic doping agent is at least distributed inside of each of the ridge-like protrusions, the metallic doping agent includes at least one of Titanium, Vanadium, Chromium, Titanium oxide, Vanadium oxide, Chromium oxide. It should be mentioned that “mainly made of” means the component with the highest weight percentage.

It is favorable for forming a gradient refractive index via the ridge-like protrusions, and also favorable for providing excellent performance with low reflectivity corresponding to light with different wavelengths and different incident angles of light. Further, since the stray light is easily to be formed on the light blocking portion which is close to the optical axis, it is favorable for enhancing the image quality by disposing the anti-reflecting thin film. Moreover, it is favorable for improving the tolerance of the nano structure layer to the environment by including the metallic doping agent, so that the effect to the layer structure from the environment variation can be decreased, and the anti-reflecting performance of the anti-reflecting thin film can also be maintained.

Further, the metallic doping agent can be selected from Tantalum, Zirconium, Niobium, Tantalum oxide, Zirconium oxide and Niobium oxide, and the environment variation can be temperature, humidity or other chemical interference, but will not be limited thereto.

Furthermore, the height of each ridge-like protrusion can be defined as, observed from the cross-sectional view (which is destructive measurement), a vertical height from an absolute bottom of each ridge-like protrusion (which is the foot of each ridge-like protrusion) to the top of each ridge-like protrusion (which is the peak of each ridge-like protrusion). The height of each ridge-like protrusion might be different, so that an average structure height can be measured by at least three or more ridge-like protrusions, and the ridge-like protrusions with identifiable outlines can be taken first.

The detection and analysis of the metallic doping agent can be achieved by Transmission Electron Microscope (TEM) or Energy-dispersive X-ray spectroscopy (EDS) of Scanning Electron Microscope (SEM). The distribution of the metal elements is the main basis for judgement regardless of whether the metallic doping agent exists in the form of metal elements or oxides.

In detail, the conditions and analysis steps of TEM and EDS are stated as follows. (1) A conductive layer with 10 nm to 20 nm is plated for observing and searching the measuring position by SEM, wherein the conductive layer can be Platinum. (2) A piece with a thickness in about 50 nm to 100 nm is sectioned by Focused Ion Beam (FIB). (3) A sample is taken by a probe, and the sample is disposed on a copper grid for being EDS detected by TEM. (4) Field Emission Transmission Electron Microscope (FE-TEM) is used, wherein the acceleration voltage is 200 KeV, the EDS sampling time is 400 seconds, and the corresponding energy intensity is given according to the material of the structure.

The surface of the optical element can be roughened, such as sandblasting or laser, which can scatter stray light. The surface of the nano structure layer can have a plurality of holes, so that the variation of equivalent refractive index of the nano structure layer can be more linear by the holes. There is no other shielding element between the light blocking portion and the optical axis.

The light blocking portion can include an object-side surface, an image-side surface and a connecting surface. The object-side surface is close to an object-side direction of the imaging lens assembly module. The image-side surface is relative to the object-side surface. The connecting surface connects the object-side surface and the image-side surface. The connecting surface is closer to the optical axis than the object-side surface and the image-side surface to the optical axis, and the anti-reflecting thin film is disposed at least on the connecting surface.

The anti-reflecting thin film can be further disposed on the object-side surface or the image-side surface. Therefore, it is favorable for restraining stray light along the object side direction or the image side direction.

The light blocking portion can further include a first end surface and a second end surface. The first end surface is tilted relative to the optical axis. The second end surface connects to the first end surface, wherein a folded angle is formed between the first end surface and the second end surface. The folded angle is closer to the optical axis than the first end surface and the second end surface to the optical axis, the anti-reflecting thin film is disposed at least on the folded angle, and when the folded angle is θC, the following condition is satisfied: 9 degrees<θC<162 degrees. Therefore, it is favorable for changing the reflective path of stray light by arranging the first end surface tilted relative to the optical axis, so that the image quality affected by stray light can be avoided. The possibility of stray light to be reflected can be reduced by the folded angle, and it is favorable for further reducing the reflection of stray light by extending the anti-reflecting thin film to the folded angle. It is easier to reflect stray light by arranging the folded angle closer to the optical axis. In detail, the folded angle can be chamfered angle, rounded angle, edged angle, etc., for connecting two end surfaces.

The anti-reflecting thin film can be further disposed on the first end surface and the second end surface.

The intermediate layer can be mainly made of Silicon dioxide. Therefore, it is favorable for enhancing the connecting stability between the anti-reflecting thin film and the optical element. Further, the number of the intermediate layer can be a plurality so as to form a multi-layer structure, which can be alternately stacked by the layers with high refractive index and the layers with low refractive index. Therefore, the refractive index can be decreased by forming a thin film interference structure.

A main component of the at least one intermediate layer can be the same with a part of components of the nano structure layer. Therefore, it is favorable for connecting the nano structure layer. Specifically, the aforementioned component (the same component) can be Aluminum, Titanium, Vanadium, Chromium, Aluminum oxide, Titanium oxide, Vanadium oxide or Chromium oxide.

The metallic doping agent is further distributed on one surface of each of the ridge-like protrusions. Therefore, it is favorable for protecting the ridge-like protrusions away from the structure variation due to the environment changes, so that the anti-reflecting function can be maintained. Moreover, the component of the metallic doping agent distributed on the surface of each of the ridge-like protrusions and the component of the metallic doping agent distributed inside each of the ridge-like protrusions can be the same or different.

The metallic doping agent distributed inside each of the ridge-like protrusions can be tapered away from the optical element. Therefore, it is favorable for adjusting the equivalent refractive index therein so as to enhance the weather resistance of ridge-like protrusions and maintain the anti-reflecting function.

The metallic doping agent can be Titanium or Titanium oxide. Specifically, it is favorable for enhancing the stability of the anti-reflecting thin film by using the Titanium as the metallic doping agent.

The anti-reflecting thin film can further include a dark layer disposed between the intermediate layer and the optical element, which is for providing a dark appearance of the optical element. Therefore, it is favorable for absorbing light by changing the appearance color of the optical element. Further, the dark layer can be a black ink spray layer made of quick-drying ink based on epoxy resin, a black coating layer formed by a chemical vapor deposition, a photoresistive coating layer, or other dark coatings with light absorption effects.

When a shortest distance between the light blocking portion and the optical axis is DO, the following condition is satisfied: 0.01 mm≤DO≤6.8 mm. Therefore, it is favorable for controlling stray light on the peripheral area of the optical axis. Further, the following condition can be satisfied: 0.5 mm≤DO≤5.2 mm.

When a coverage thickness of the metallic doping agent on the surface of each of the ridge-like protrusions is TM, the following condition is satisfied: 1 nm≤TM≤40 nm. Therefore, it is favorable for maintaining the shape of the ridge-like protrusions and also enhancing the weather resistance thereof by obtaining the proper thickness condition. Specifically, the coverage thickness can be measured by the average of several thicknesses on different position. Further, the following condition can be satisfied: 1 nm≤TM≤30 nm.

Each of the aforementioned features of the imaging lens assembly module can be utilized in various combinations for achieving the corresponding effects.

According to one aspect of the present disclosure, an electronic device includes the aforementioned imaging lens assembly module.

According to the above description of the present disclosure, the following specific embodiments are provided for further explanation.

### 1st Embodiment

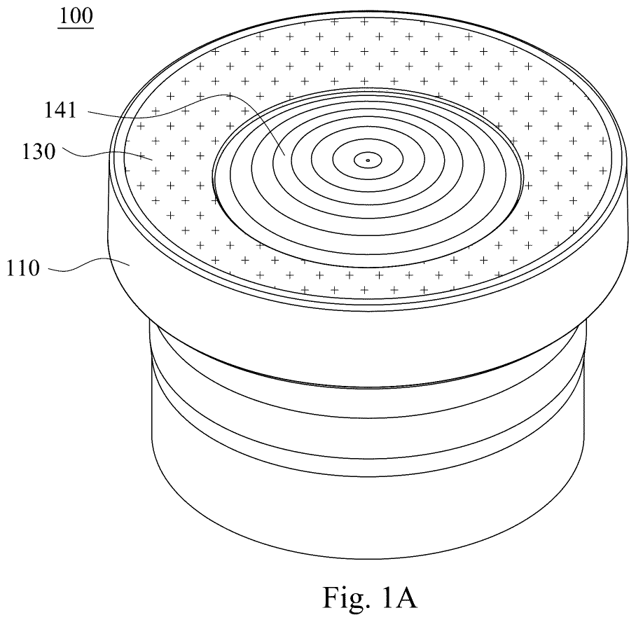

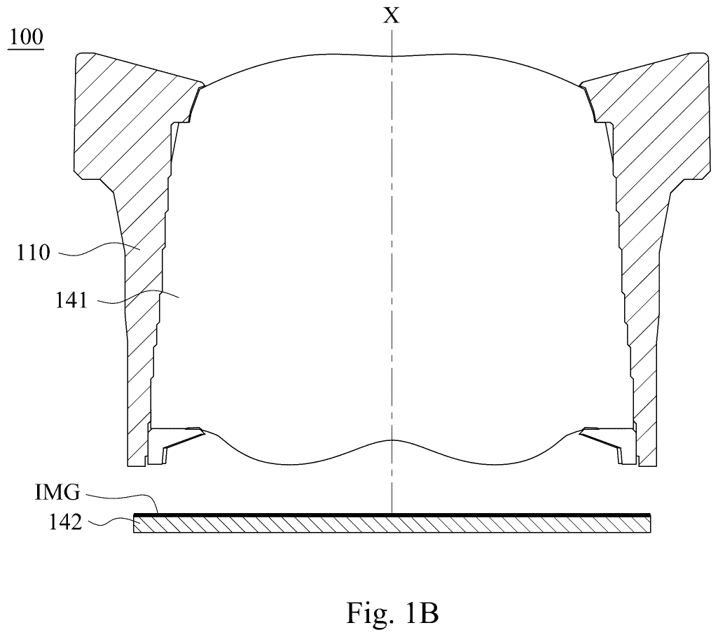

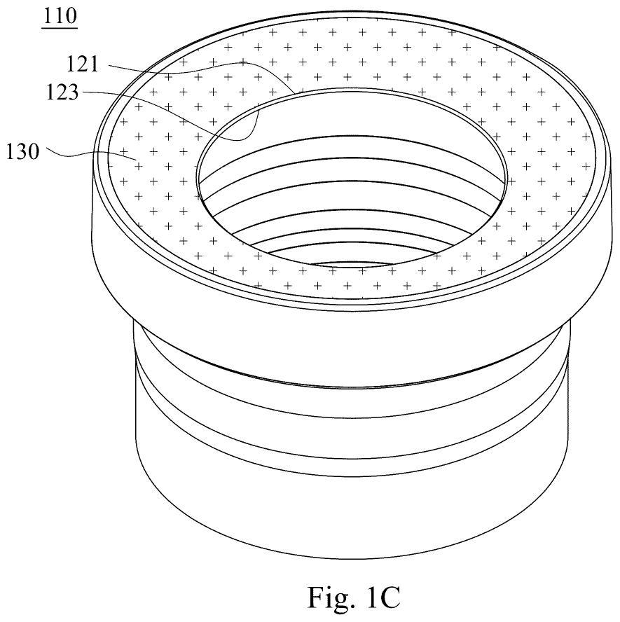

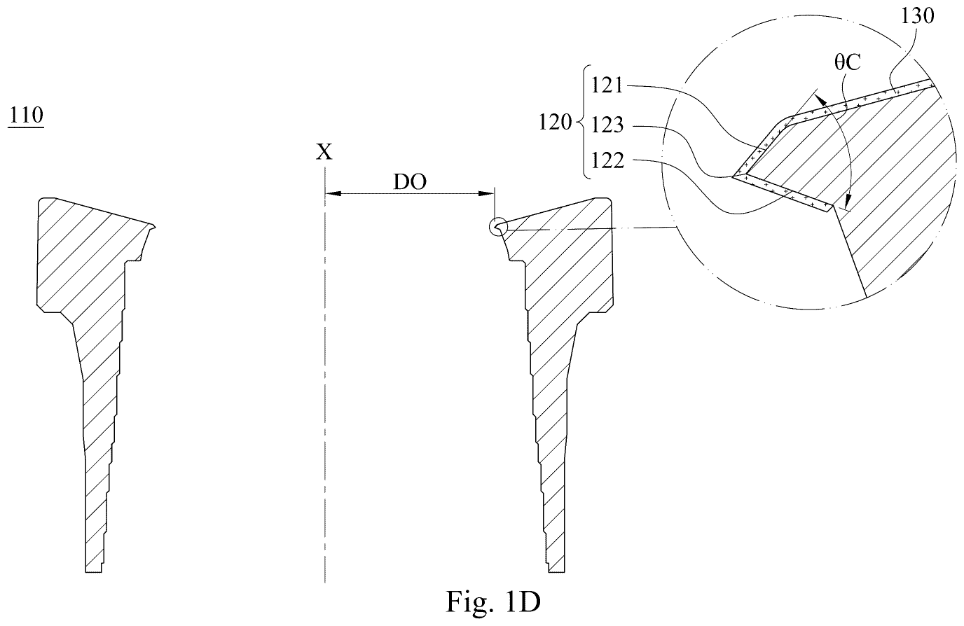

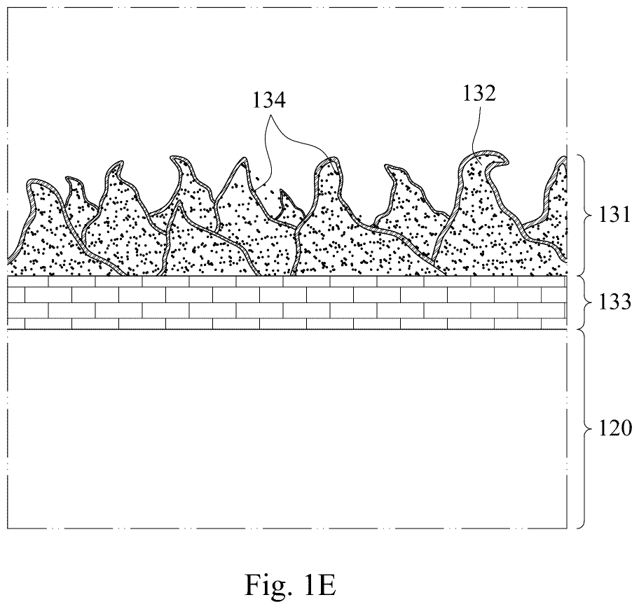

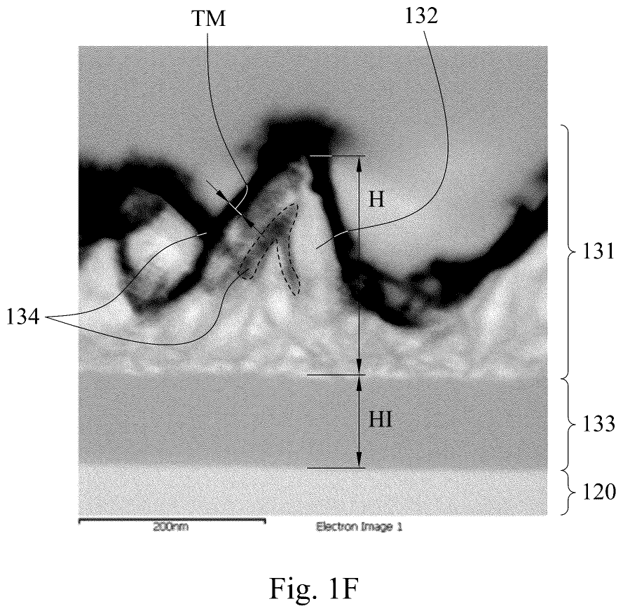

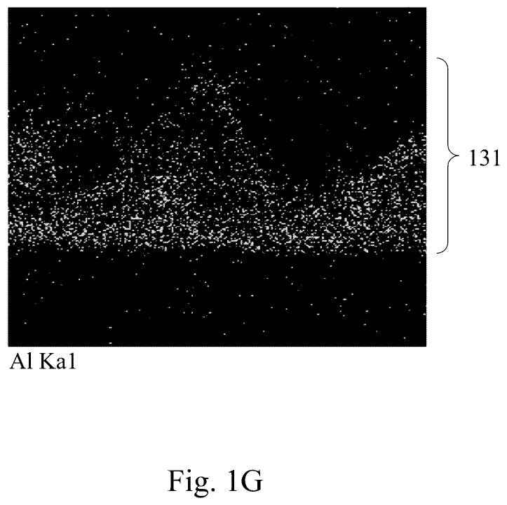

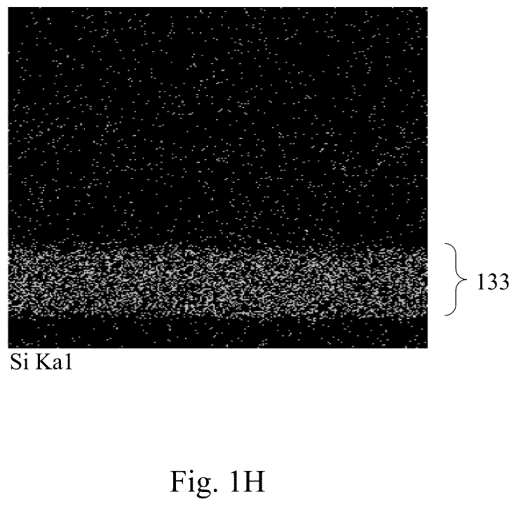

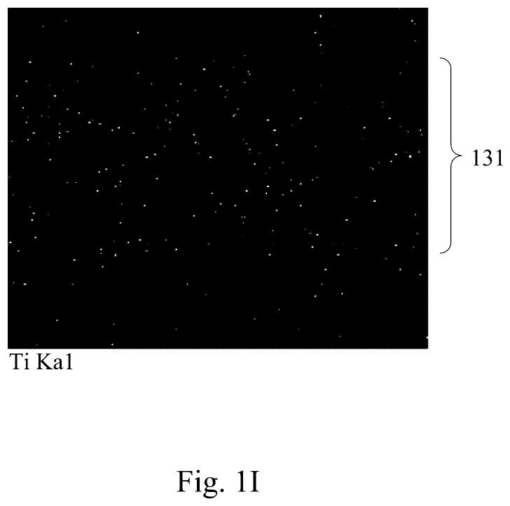

FIG. 1A is a three-dimensional view of an imaging lens assembly module 100 according to the 1st embodiment of the present disclosure. FIG. 1B is a schematic view of the imaging lens assembly module 100 according to the 1st embodiment of FIG. 1A. In FIG. 1A and FIG. 1B, the imaging lens assembly module 100 defines an optical axis X, and includes an optical element 110, a lens element 141 and an image sensor 142, wherein the optical element 110 is a lens barrel, the optical element 110 is for accommodating the lens element 141, and the image sensor 142 is disposed on an image surface IMG of the imaging lens assembly module 100. In detail, a surface of the optical element 110 can be roughened, such as sandblasting or laser, which can scatter stray light.

FIG. 1C is a three-dimensional view of the optical element 110 according to the 1st embodiment of FIG. 1A. FIG. 1D is a partial enlarged view of the optical element 110 according to the 1st embodiment of FIG. 1C. FIG. 1E is a schematic view of an anti-reflecting thin film 130 and a light blocking portion 120 according to the 1st embodiment of FIG. 1A. In FIG. 1A and FIG. 1C to FIG. 1E, the optical element 110 includes the light blocking portion 120 and the anti-reflecting thin film 130. The light blocking portion 120 is opaque, and the light blocking portion 120 is closer to the optical axis X than the other portion of the optical element 110 to the optical axis X. The anti-reflecting thin film 130 is disposed at least on a surface of the light blocking portion 120. The anti-reflecting thin film 130 incudes a nano structure layer 131 and at least one intermediate layer 133, wherein the intermediate layer 133 is disposed between the nano structure layer 131 and the optical element 110. The nano structure layer 131 has a plurality of ridge-like protrusions 132 which extends non-directionally, wherein a bottom of each of the ridge-like protrusions 132 is closer to the optical element 110 of a top of each of the ridge-like protrusions 132, each of the ridge-like protrusions 132 tapers from the bottom to the top.

It is favorable for forming a gradient refractive index via the ridge-like protrusions 132, and also favorable for providing excellent performance with low reflectivity corresponding to light with different wavelengths and different incident angles of light. Further, since the stray light is easily to be formed on the light blocking portion 120 which is close to the optical axis X, it is favorable for enhancing the image quality by disposing the anti-reflecting thin film 130.

Further, the surface of the nano structure layer 131 can have a plurality of holes, so that the variation of equivalent refractive index of the nano structure layer 131 can be more linear by the holes.

It should be mentioned that, in FIG. 1E, the dotted area is the area of the metallic doping agent 134.

FIG. 1F is a cross-sectional view from TEM of the anti-reflecting thin film 130 and the light blocking portion 120 according to the 1st embodiment of FIG. 1E. FIG. 1G is an elemental map of Aluminum in the anti-reflecting thin film 130 according to the 1st embodiment of FIG. 1F. FIG. 1H is an elemental map of Silicon in the anti-reflecting thin film 130 according to the 1st embodiment of FIG. 1F. FIG. 1I is an elemental map of Titanium in the anti-reflecting thin film 130 according to the 1st embodiment of FIG. 1F. In FIG. 1F to FIG. 1I, the nano structure layer 131 is mainly made of Aluminium oxide. The nano structure layer 131 includes the metallic doping agent 134, wherein the metallic doping agent 134 is at least distributed inside of each of the ridge-like protrusions 132, the metallic doping agent 134 is made of Titanium oxide so as to enhance the stability of the anti-reflecting thin film 130. It should be mentioned that “mainly made of” means the component with the highest weight percentage.

It is favorable for improving the tolerance of the nano structure layer 131 to the environment by including the metallic doping agent 134, so that the effect to the layer structure from the environment variation can be decreased, and the anti-reflecting performance of the anti-reflecting thin film 130 can also be maintained. Further, the environment variation can be temperature, humidity or other chemical interference, but will not be limited thereto.

In FIG. 1D, the light blocking portion 120 can include a first end surface 121 and a second end surface 122, wherein the first end surface 121 is tilted relative to the optical axis X, the second end surface 122 connects to the first end surface 121, wherein an folded angle 123 is formed between the first end surface 121 and the second end surface 122. Therefore, it is favorable for changing the reflection path of stray light by disposing the first end surface 121 tilted relative to the optical axis X, so that it is favorable for avoiding the image quality affected by stray light.

The folded angle 123 is closer to the optical axis X than the first end surface 121 and the second end surface 122 to the optical axis X, the anti-reflecting thin film 130 is disposed at least on the folded angle 123, wherein the folded angle 123 is an edged angle, and the location of the anti-reflecting thin film 130 can be extended to the first end surface 121 and the second end surface 122. Therefore, it is favorable for decreasing the possibility of the reflection of stray light via the folded angle 123, and it is favorable for further reducing the reflection of stray light by extending the anti-reflecting thin film 130 to the folded angle 123. Further, it is easier to reduce the reflection of stray light by disposing the folded angle 123 closer to the optical axis X.

In FIG. 1H, the intermediate layer 133 can be mainly made of Silicon dioxide (SiO₂). Therefore, it is favorable for enhancing the connecting stability between the anti-reflecting thin film 130 and the optical element 110. Further, the number of the intermediate layer 133 can be a plurality so as to form a multi-layer structure, which can be alternately stacked by the layers with high refractive index and the layers with low refractive index. Therefore, the refractive index can be decreased by forming a thin film interference structure.

In FIG. 1E, FIG. 1F and FIG. 1I, the metallic doping agent 134 is further distributed on one surface of each of the ridge-like protrusions 132. Therefore, it is favorable for protecting the ridge-like protrusions 132 away from the structure variation due to the environment changes, so that the anti-reflecting function can be maintained. Moreover, the component of the metallic doping agent 134 distributed on the surface of each of the ridge-like protrusions 132 and the component of the metallic doping agent 134 distributed inside each of the ridge-like protrusions 132 can be the same or different.

The metallic doping agent 134 distributed inside each of the ridge-like protrusions 132 can be tapered away from the optical element 110. Therefore, it is favorable for adjusting the equivalent refractive index therein so as to enhance the weather resistance of ridge-like protrusions 132 and maintain the anti-reflecting function.

In FIG. 1D and FIG. 1F, when a shortest distance between the light blocking portion 120 and the optical axis X is DO, the folded angle 123 is θC, a coverage thickness of the metallic doping agent 134 on the surface of each of the ridge-like protrusions 132 is TM, a perpendicular height of one of the ridge-like protrusions 132 is H, and a thickness of the intermediate layer 133 is HI, the parameters can satisfy the conditions in Table 1 as follows.

TABLE 1
1st Embodiment

| | | | |
|---|---|---|---|
| DO (mm) | 3.26 | H (nm) | 240.1 |
| θC (degrees) | 70 | HI (nm) | 96.1 |
| TM (nm) | 18.4 | | |

In detail, an average structure height of the ridge-like protrusions 132 is greater than 108 nm and smaller than 368 nm. The height of each ridge-like protrusion 132 can be defined as, observed from the cross-sectional view (which is destructive measurement), a vertical height from an absolute bottom of each ridge-like protrusion 132 (which is the foot of each ridge-like protrusion 132) to the top of each ridge-like protrusion 132 (which is the peak of each ridge-like protrusion 132). Further, the height of each ridge-like protrusion 132 might be different, so that the average structure height can be measured by at least three or more ridge-like protrusions 132, and the ridge-like protrusions 132 with identifiable outlines can be taken first.

It should be mentioned that the anti-reflecting thin film 130 and light blocking portion 120 in FIG. 1G to FIG. 1I are relative to the structural arrangement in FIG. 1F, wherein the detection and analysis of the metallic doping agent 134 can use EDS of TEM or SEM. The distribution of the metal elements is the main basis for judgement regardless of whether the metallic doping agent exists in the form of metal elements or oxides. Further, the distribution of the metallic doping agent 134 in the nano structure layer 131 can be analyzed by FIG. 11.

### 2nd Embodiment

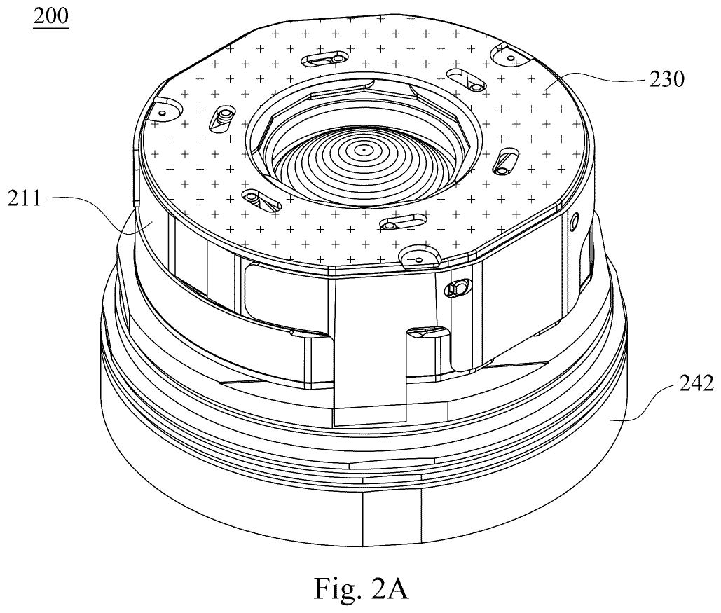

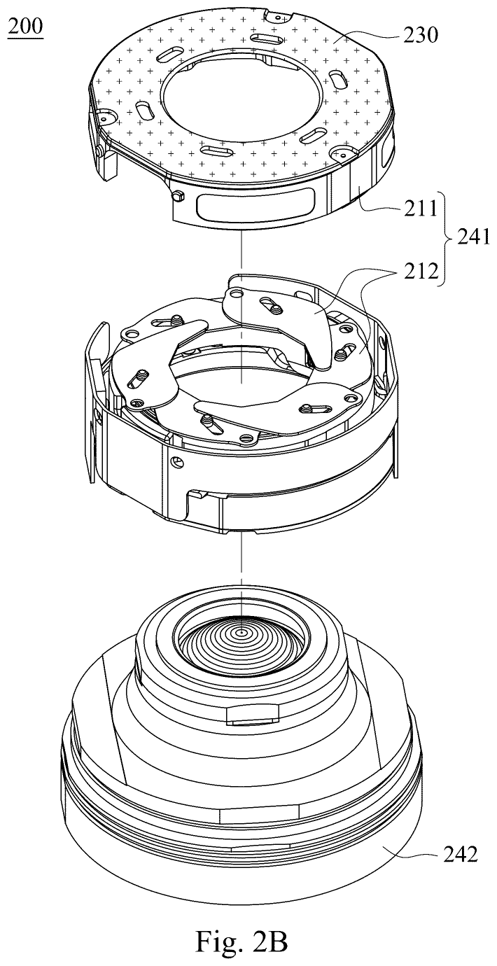

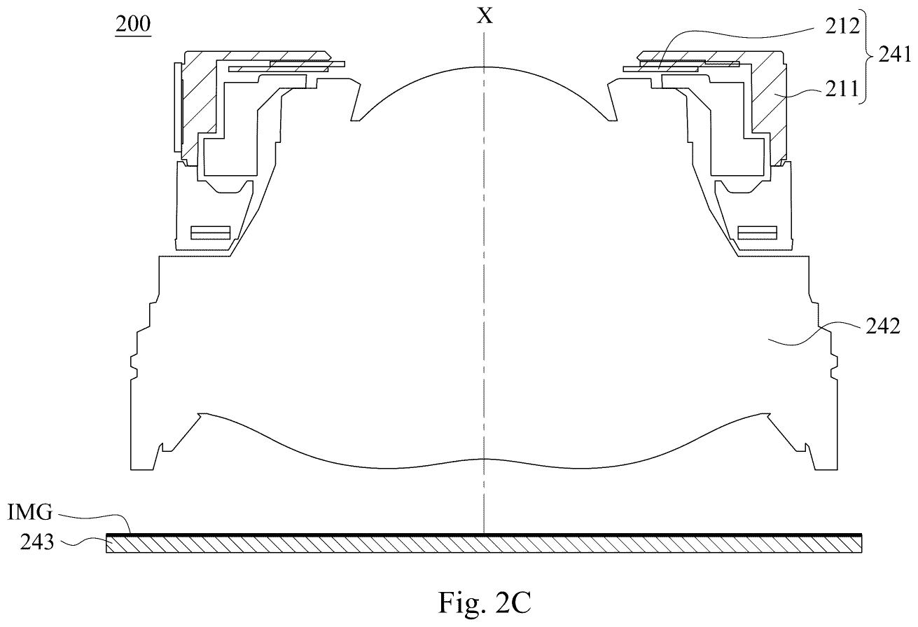

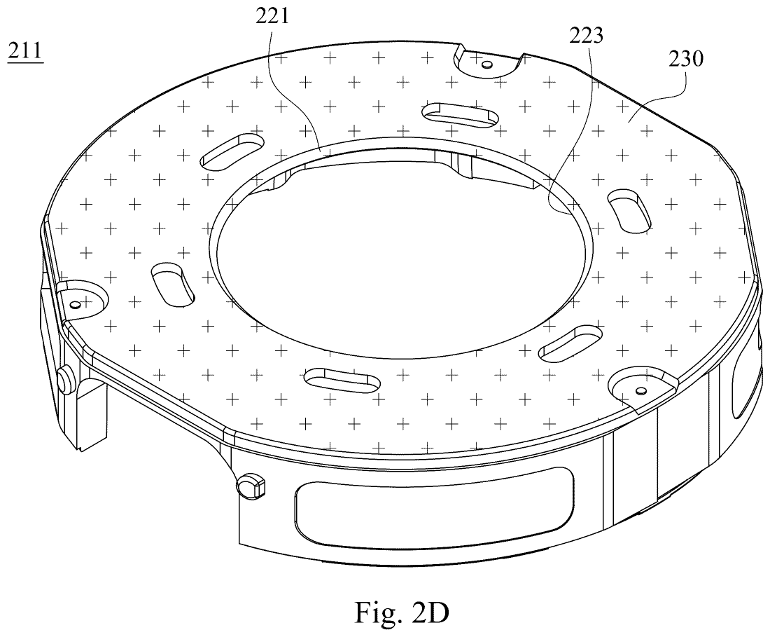

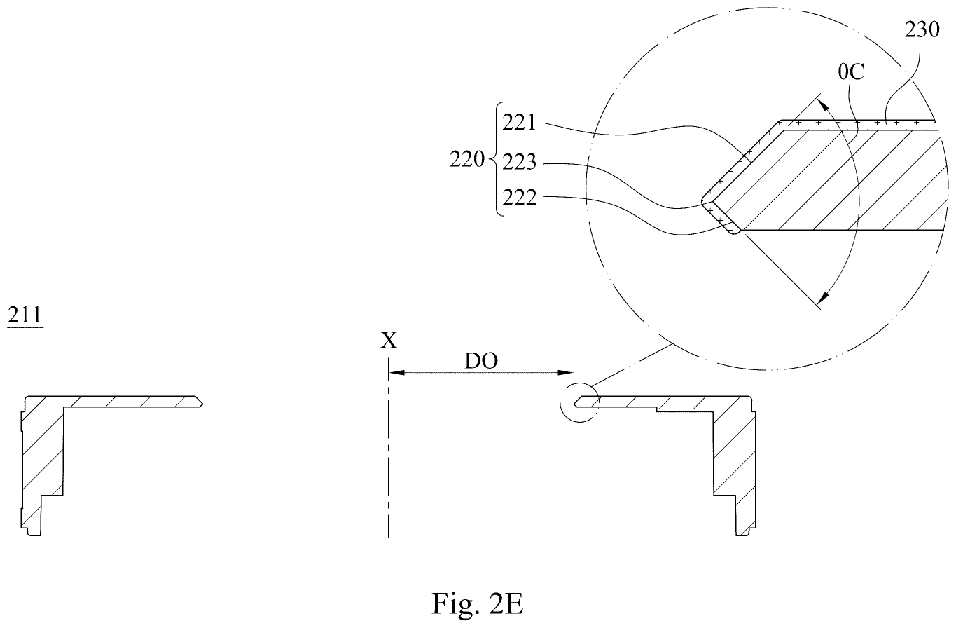

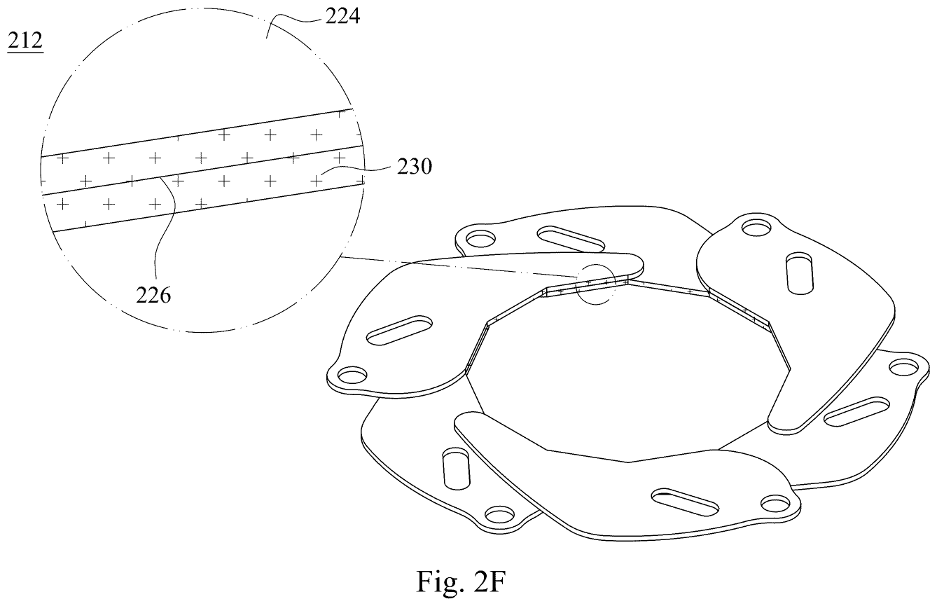

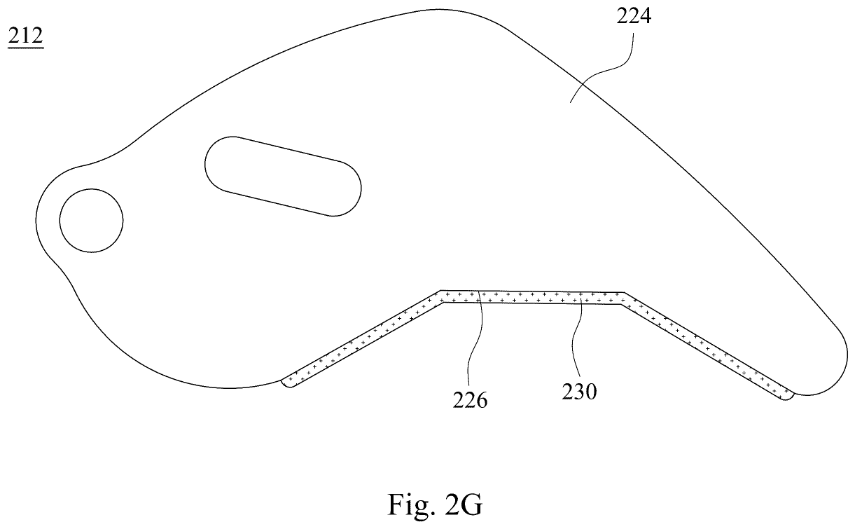

FIG. 2A is a three-dimensional view of an imaging lens assembly module 200 according to the 2nd embodiment of the present disclosure. FIG. 2B is an exploded view of the imaging lens assembly module 200 according to the 2nd embodiment of FIG. 2A. FIG. 2C is a schematic view of the imaging lens assembly module 200 according to the 2nd embodiment of FIG. 2A. In FIG. 2A to FIG. 2C, the imaging lens assembly module 200 defines an optical axis X, and includes optical elements 211, 212, a lens assembly 242 and an image sensor 243. The optical element 211 is a cover of a variable aperture, the optical elements 212 are blades of the variable aperture, wherein the variable aperture can be made of the optical elements 211, 212, and the variable aperture is disposed on the lens assembly 242. The image sensor 243 is disposed on an image surface IMG of the imaging lens assembly module 200.

FIG. 2D is a three-dimensional view of the optical element 211 according to the 2nd embodiment of FIG. 2A. FIG. 2E is a partial enlarged view of the optical element 211 according to the 2nd embodiment of FIG. 2D. In FIG. 2A, FIG. 2B, FIG. 2D and FIG. 2E, the optical element 211 includes a light blocking portion 220 and an anti-reflecting thin film 230. The light blocking portion 220 is opaque, and the light blocking portion 220 is closer to the optical axis X than the other portion of the optical element 211 to the optical axis X. The anti-reflecting thin film 230 is disposed at least on a surface of the light blocking portion 220. The anti-reflecting thin film 230 incudes a nano structure layer and at least one intermediate layer, wherein the intermediate layer is disposed between the nano structure layer and the optical element 211. The nano structure layer has a plurality of ridge-like protrusions which extends non-directionally, wherein a bottom of each of the ridge-like protrusions is closer to the optical element 211 of a top of each of the ridge-like protrusions, each of the ridge-like protrusions tapers from the bottom to the top.

The nano structure layer is mainly made of Aluminium oxide. The nano structure layer includes the metallic doping agent, wherein the metallic doping agent is at least distributed inside of each of the ridge-like protrusions, the metallic doping agent is made of at least one of Titanium, Vanadium, Chromium, Titanium oxide, Vanadium oxide, Chromium oxide. Further, the metallic doping agent can be selected from Tantalum, Zirconium, Niobium, Tantalum oxide, Zirconium oxide and Niobium oxide.

In FIG. 2E, the light blocking portion 220 can include a first end surface 221 and a second end surface 222, wherein the first end surface 221 is tilted relative to the optical axis X, the second end surface 222 connects to the first end surface 221. A folded angle 223 is formed between the first end surface 221 and the second end surface 222. Further, the folded angle 223 is closer to the optical axis X than the first end surface 221 and the second end surface 222 to the optical axis X, the anti-reflecting thin film 230 is disposed at least on the folded angle 223, wherein the folded angle 223 is an edged angle, and the location of the anti-reflecting thin film 230 can be extended to the first end surface 221 and the second end surface 222.

FIG. 2F is a three-dimensional view of the optical elements 212 according to the 2nd embodiment of FIG. 2A. FIG. 2G is a partial schematic view of the optical elements 212 according to the 2nd embodiment of FIG. 2F. In FIG. 2F and FIG. 2G, each of the optical elements 212 includes a light blocking portion and an anti-reflecting thin film 230. The light blocking portion includes an object-side surface 224, an image-side surface and a connecting surface 226. The object-side surface 224 is close to an object-side direction of the imaging lens assembly module 200, the image-side surface is relative to the object-side surface 224, and the connecting surface 226 connects the object-side surface 224 and the image-side surface. Further, the connecting surface 226 is closer to the optical axis X than the object-side surface 224 and the image-side surface to the optical axis X, and the anti-reflecting thin film is only disposed on the connecting surface 226.

In FIG. 2C, there is no other shielding element between each of the optical elements 211, 212 and the optical axis X.

In FIG. 2E, when a shortest distance between the light blocking portion 220 and the optical axis X is DO, the folded angle 223 is θC, the parameters can satisfy the conditions in Table 2 as follows.

TABLE 2
2nd Embodiment

| | | | |
|---|---|---|---|
| DO (mm) | 2.4 | θC (degrees) | 90 |

### 3rd Embodiment

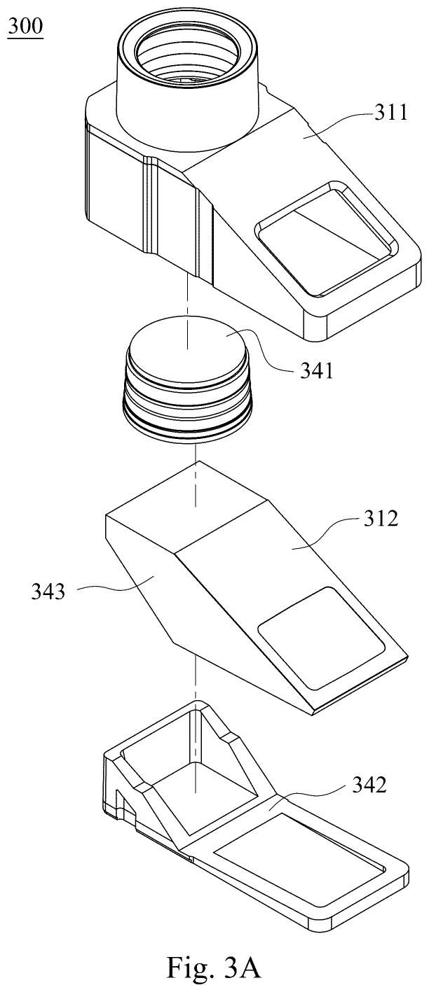

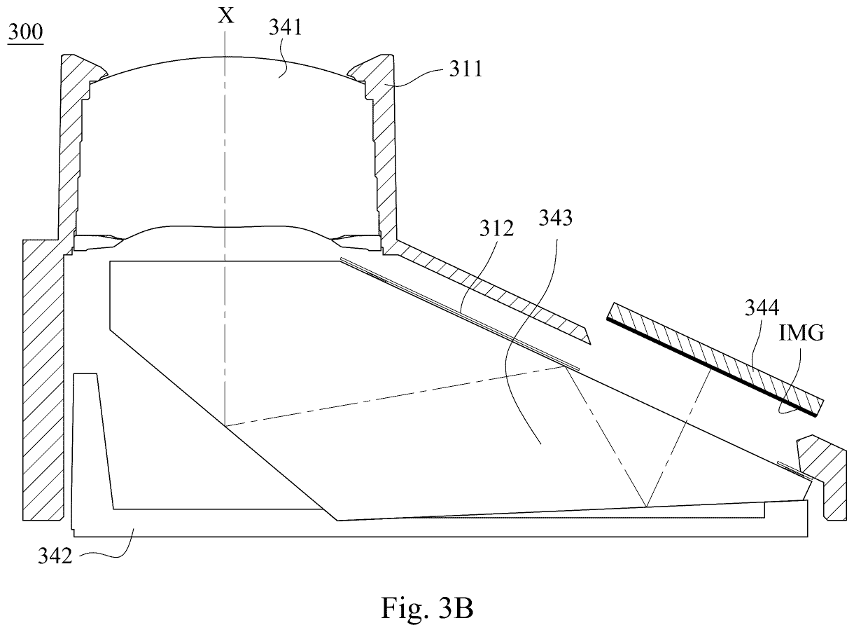

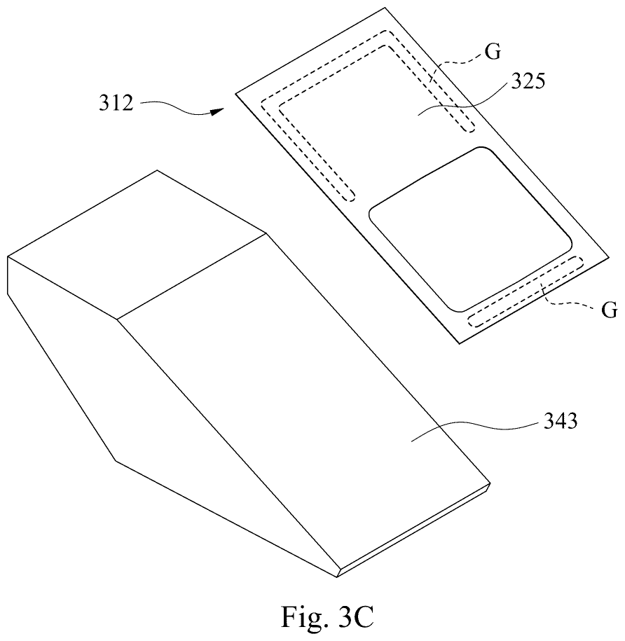

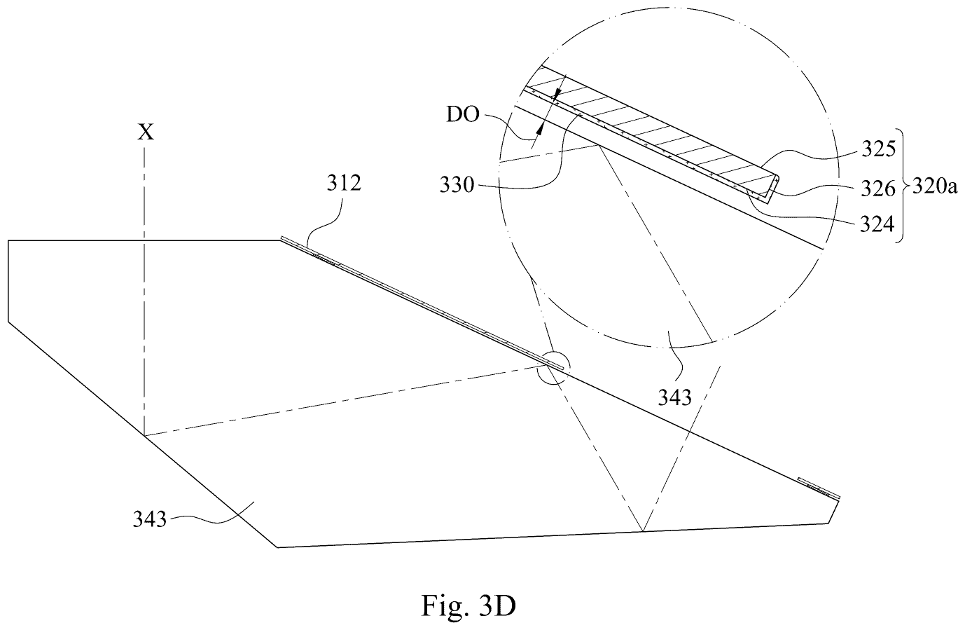

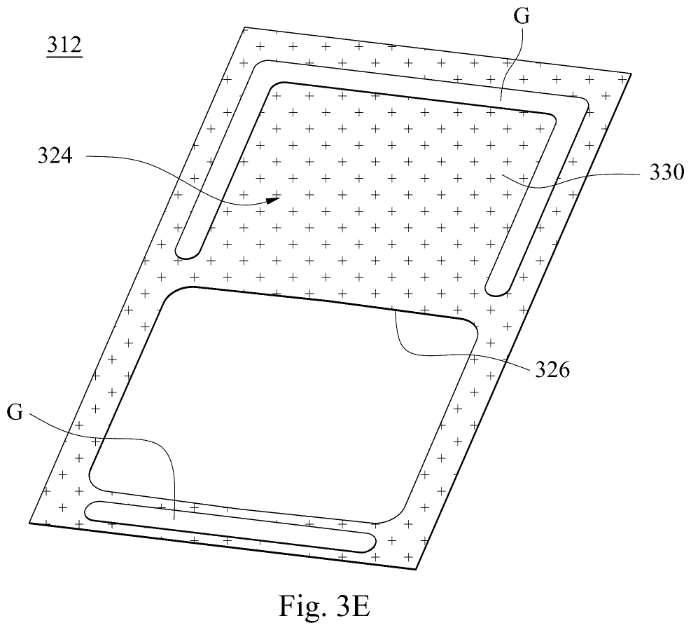

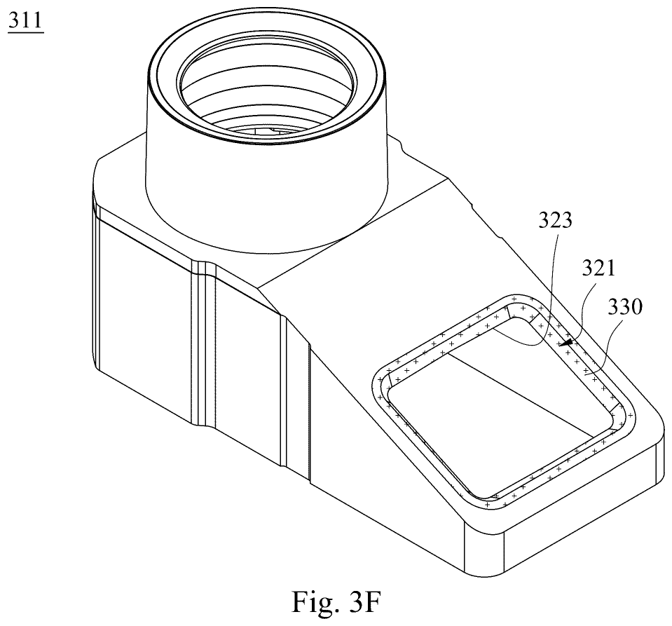

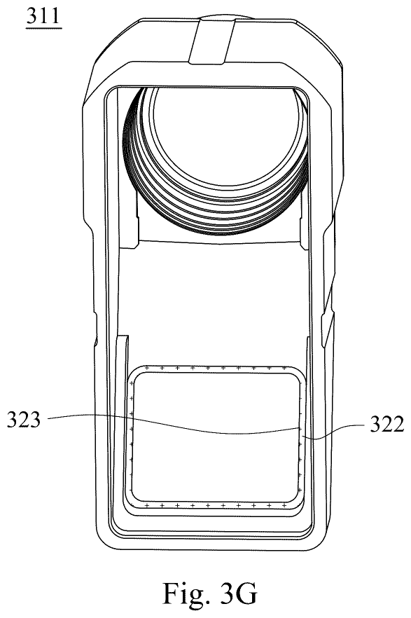

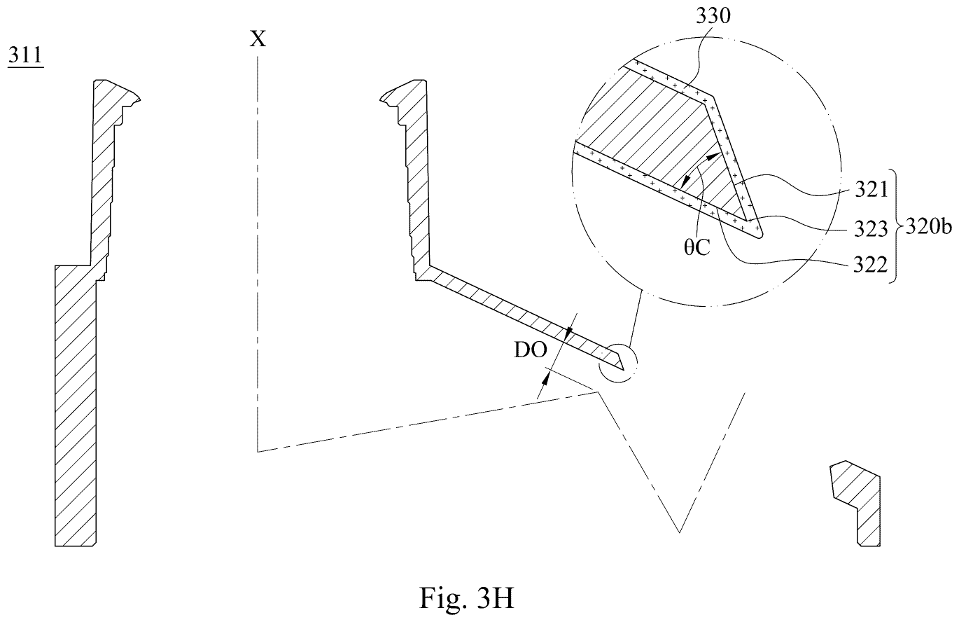

FIG. 3A is an exploded view of an imaging lens assembly module 300 according to the 3rd embodiment of the present disclosure. FIG. 3B is a schematic view of the imaging lens assembly module 300 according to the 3rd embodiment of FIG. 3A. In FIG. 3A and FIG. 3B, the imaging lens assembly module 300 defines an optical axis X, and includes optical elements 311, 312, a lens element 341, an assembling element 342, a reflective element 343 and an image sensor 344. The optical element 311 is a lens barrel, the optical element 312 is a light blocking sheet. The optical element 311 is for accommodating the lens element 341, the reflective element 343 and the optical element 312, the assembling element 342 is for positioning the reflective element 343, and the image sensor 344 is disposed on an image surface IMG of the imaging lens assembly module 300.

In detail, the optical axis X in the imaging lens assembly module 300 can be folded by the reflective element 343, and the optical axis X after folded is defined as the same optical axis.

FIG. 3C is a three-dimensional view of the optical element 312 and the reflective element 343 according to the 3rd embodiment of FIG. 3A. FIG. 3D is an assembled schematic view of the optical element 312 and the reflective element 343 according to the 3rd embodiment of FIG. 3A. FIG. 3E is a schematic view of the optical element 312 according to the 3rd embodiment of FIG. 3A. In FIG. 3C to FIG. 3E, the optical element 312 includes a light blocking portion 320a and an anti-reflecting thin film 330. The light blocking portion 320a is opaque, and the light blocking portion 320a is closer to the optical axis X than the other portion of the optical element 312 to the optical axis X. The anti-reflecting thin film 330 is disposed at least on a surface of the light blocking portion 320a. The anti-reflecting thin film 330 incudes a nano structure layer and at least one intermediate layer, wherein the intermediate layer is disposed between the nano structure layer and the optical element 312. The nano structure layer has a plurality of ridge-like protrusions which extends non-directionally, wherein a bottom of each of the ridge-like protrusions is closer to the optical element 312 of a top of each of the ridge-like protrusions, each of the ridge-like protrusions tapers from the bottom to the top.

The nano structure layer is mainly made of Aluminium oxide. The nano structure layer includes the metallic doping agent, wherein the metallic doping agent is at least distributed inside of each of the ridge-like protrusions, the metallic doping agent is made of at least one of Titanium, Vanadium, Chromium, Titanium oxide, Vanadium oxide, Chromium oxide.

In FIG. 3D, the light blocking portion 320a includes an object-side surface 324, an image-side surface 325 and a connecting surface 326. The object-side surface 324 is close to an object-side direction of the imaging lens assembly module 300, the image-side surface 325 is relative to the object-side surface 324, and the connecting surface 326 connects the object-side surface 324 and the image-side surface 325. Further, the anti-reflecting thin film 330 is at least disposed on the connecting surface 326. Moreover, the anti-reflecting thin film 330 can be further extended to the object-side surface 324 so as to further restrain the stray light on the object-side direction.

In FIG. 3C and FIG. 3E, the optical element 312 can further include an adhesive G, wherein the adhesive G is disposed on the object-side surface 324, and the optical element 312 is connected on the reflective element 343 via the adhesive G.

FIG. 3F is a three-dimensional view of the optical element 311 according to the 3rd embodiment of FIG. 3A. FIG. 3G is another three-dimensional view of the optical element 311 according to the 3rd embodiment of FIG. 3A. FIG. 3H is a schematic view of the optical element 311 according to the 3rd embodiment of FIG. 3F. In FIG. 3F to FIG. 3H, the optical element 311 includes a light blocking portion 320b and an anti-reflecting thin film 330. The light blocking portion 320b can include a first end surface 321 and a second end surface 322, wherein the first end surface 321 is tilted relative to the optical axis X, the second end surface 322 connects to the first end surface 321, wherein an folded angle 323 is formed between the first end surface 321 and the second end surface 322. Further, the folded angle 323 is closer to the optical axis X than the first end surface 321 and the second end surface 322 to the optical axis X, the anti-reflecting thin film 330 is disposed at least on the folded angle 323, wherein the folded angle 323 is an edged angle, and the location of the anti-reflecting thin film 330 can be extended to the first end surface 321 and the second end surface 322.

In FIG. 3D and FIG. 3H, when a shortest distance between the light blocking portions 320a, 320b and the optical axis X is DO, the folded angle 323 of the light blocking portion 320b is θC, the parameters can satisfy the conditions in Table 3 as follows.

TABLE 3
3rd Embodiment

| | | | |
|---|---|---|---|
| DO (mm) | 0.05 | θC (degrees) | 45 |
| (the light blocking portion 320a) | | | |
| DO (mm) | 0.77 | | |
| (the light blocking portion 320b) | | | |

### 4th Embodiment

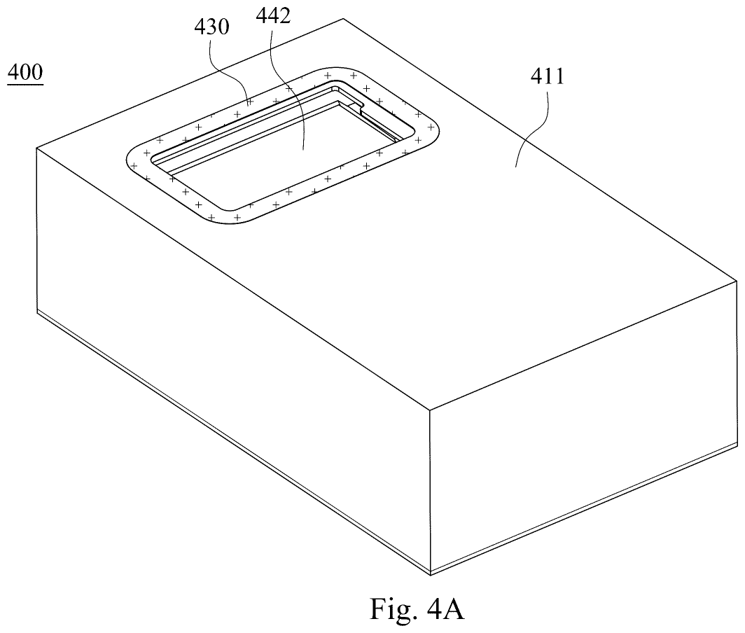

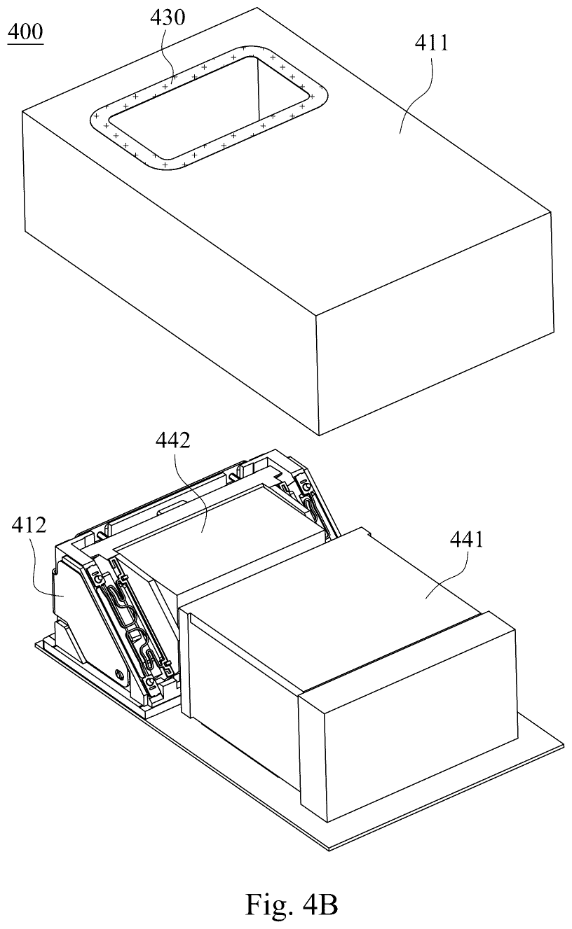

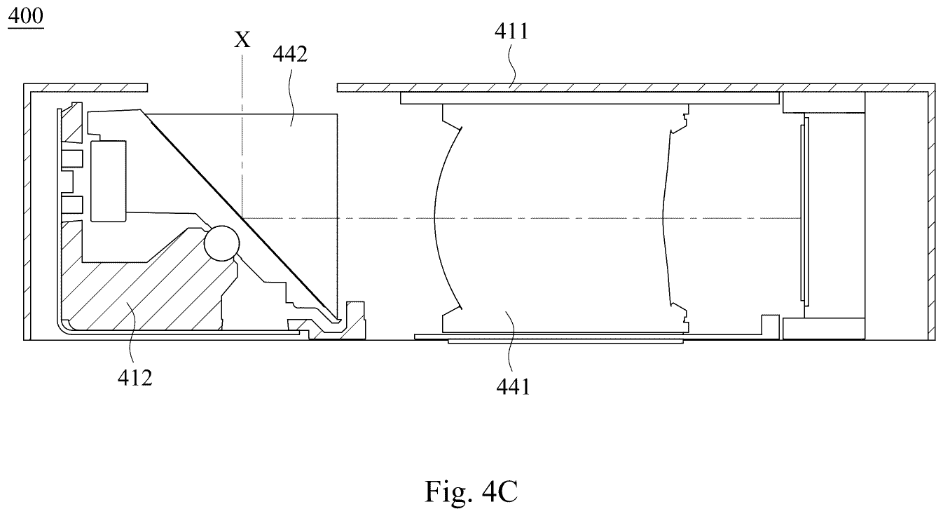

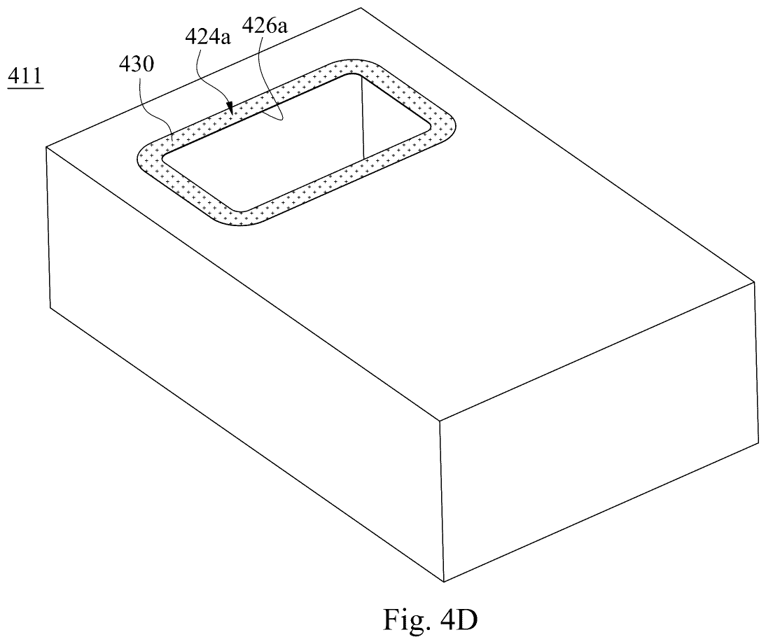

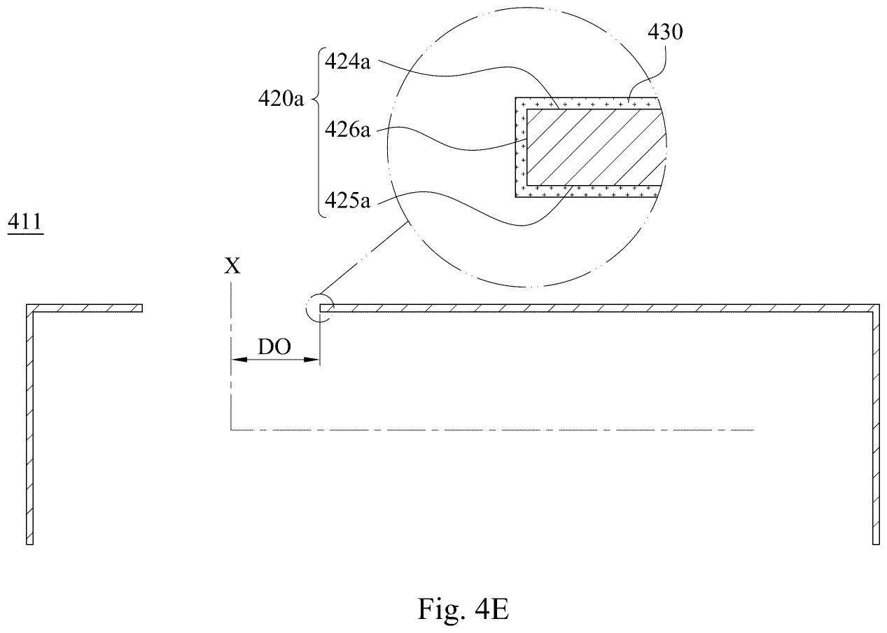

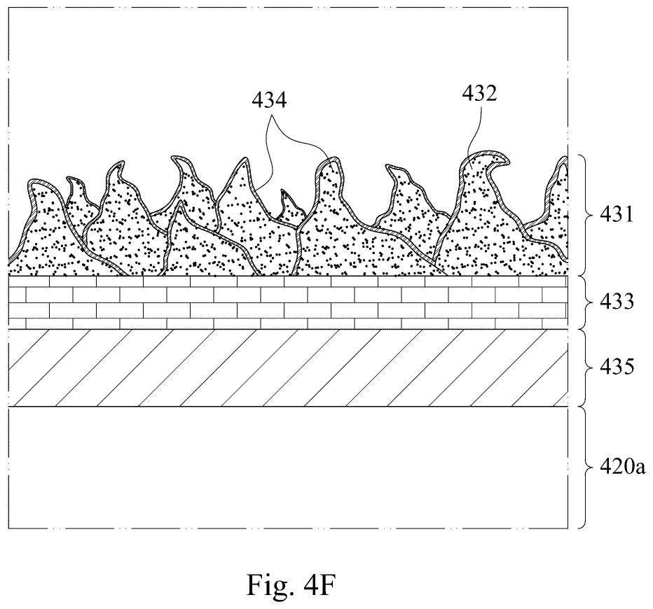

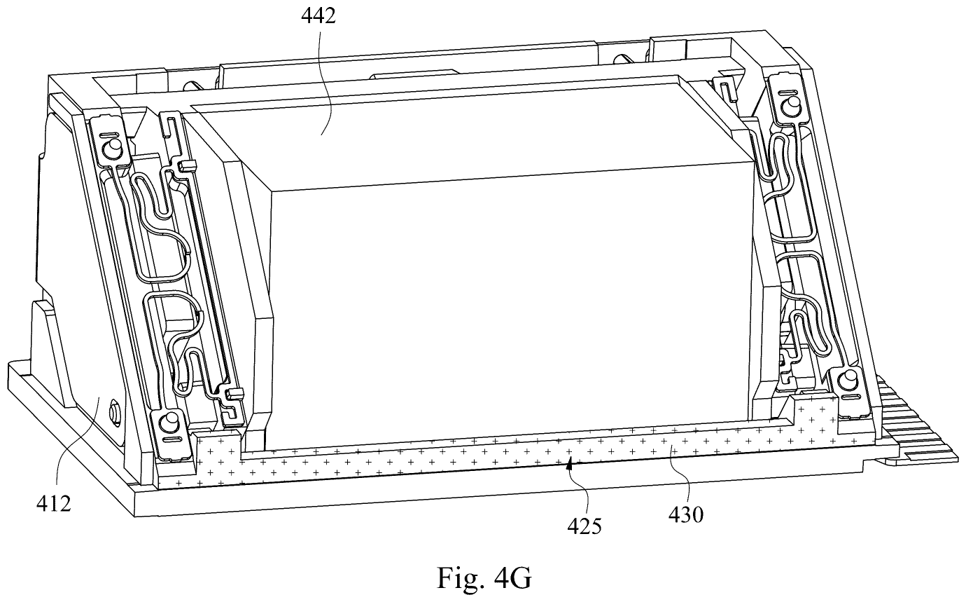

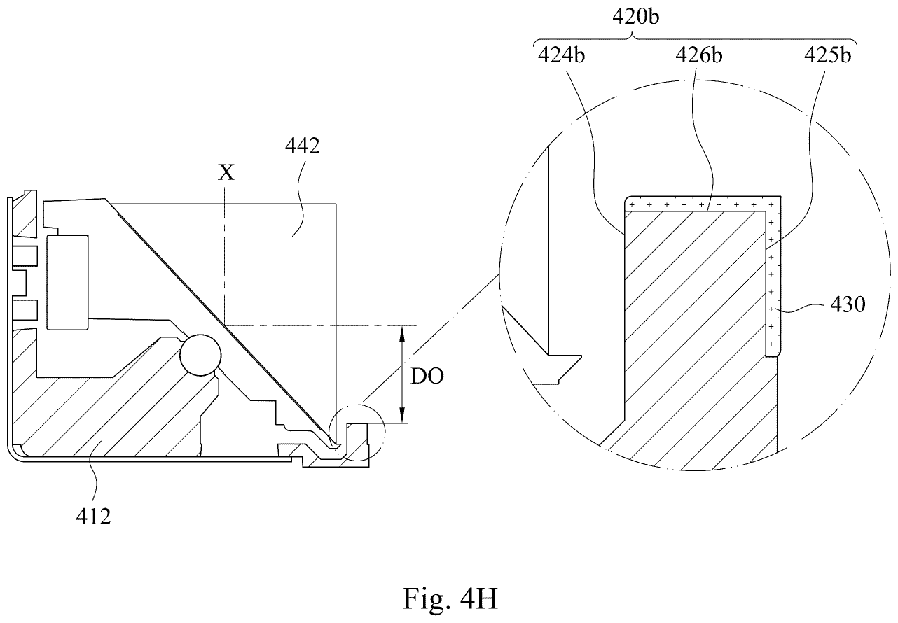

FIG. 4A is a three-dimensional view of an imaging lens assembly module 400 according to the 4th embodiment of the present disclosure. FIG. 4B is an exploded view of the imaging lens assembly module 400 according to the 4th embodiment of FIG. 4A. FIG. 4C is a schematic view of the imaging lens assembly module 400 according to the 4th embodiment of FIG. 4A. In FIG. 4A to FIG. 4C, the imaging lens assembly module 400 defines an optical axis X, and includes optical elements 411, 412, a lens element 441 and a reflective element 442. The optical element 411 is a cover, the optical element 412 is a retainer. The optical element 411 is for accommodating the optical element 412, the lens element 441 and the reflective element 442. The optical element 412 and the reflective element 442 are disposed relative to each other.

FIG. 4D is a three-dimensional view of the optical element 411 according to the 4th embodiment of FIG. 4A. FIG. 4E is a schematic view of the optical element 411 according to the 4th embodiment of FIG. 4D. FIG. 4F is a schematic view of an anti-reflecting thin film 430 and a light blocking portion 420a according to the 4th embodiment of FIG. 4D. In FIG. 4D to FIG. 4F, the optical element 411 includes a light blocking portion 420a and an anti-reflecting thin film 430. The light blocking portion 420a is opaque, and the light blocking portion 420a is closer to the optical axis X than the other portion of the optical element 411 to the optical axis X. The anti-reflecting thin film 430 is disposed at least on a surface of the light blocking portion 420a. The anti-reflecting thin film 430 incudes a nano structure layer 431 and at least one intermediate layer 433, wherein the intermediate layer 433 is disposed between the nano structure layer 431 and the optical element 411. The nano structure layer 431 has a plurality of ridge-like protrusions 432 which extends non-directionally, wherein a bottom of each of the ridge-like protrusions 432 is closer to the optical element 411 of a top of each of the ridge-like protrusions 432, each of the ridge-like protrusions 432 tapers from the bottom to the top.

The nano structure layer 431 is mainly made of Aluminium oxide. The nano structure layer 431 includes the metallic doping agent 434, wherein the metallic doping agent 434 is at least distributed inside of each of the ridge-like protrusions 432, the metallic doping agent 434 is made of at least one of Titanium, Vanadium, Chromium, Titanium oxide, Vanadium oxide, Chromium oxide.

In detail, the intermediate layer 433 is made of Titanium oxide (TiO₂), and the metallic doping agent 434 is made of Chromium oxide (CrxOy), wherein a main component of the intermediate layer 433 can be the same with a part of components of the nano structure layer 431, and the aforementioned component (the same component) can be Aluminum, Titanium, Vanadium, Chromium, Aluminum oxide, Titanium oxide, Vanadium oxide or Chromium oxide. Therefore, it is favorable for enhancing the adhesion of the nano structure layer 431.

In FIG. 4D and FIG. 4E, the light blocking portion 420a includes an object-side surface 424a, an image-side surface 425a and a connecting surface 426a. The object-side surface 424a is close to an object-side direction of the imaging lens assembly module 400, the image-side surface 425a is relative to the object-side surface 424a, and the connecting surface 426a connects the object-side surface 424a and the image-side surface 425a. Further, the connecting surface 426a is closer to the optical axis X than the object-side surface 424a and the image-side surface 425a to the optical axis X, and the anti-reflecting thin film 430 is at least disposed on the connecting surface 426. Further, the anti-reflecting thin film 430 can be further extended to the object-side surface 424a and the image-side surface 425a.

In FIG. 4F, the anti-reflecting thin film can further include a dark layer 435 disposed between the intermediate layer 433 and the optical element 411, which is for providing a dark appearance of the optical element 411. Therefore, it is favorable for absorbing light by changing the appearance color of the optical element. Further, the dark layer 435 can be a black ink spray layer made of quick-drying ink based on epoxy resin, a black coating layer formed by a chemical vapor deposition, a photoresistive coating layer, or other dark coatings with light absorption effects.

It should be mentioned that the optical element 411 is made of metal, and in FIG. 4F, the dotted area in the ridge-like protrusions 432 is the area of the metallic doping agent 134.

FIG. 4G is a three-dimensional view of the optical element 412 according to the 4th embodiment of FIG. 4A. FIG. 4H is a schematic view of the optical element 412 according to the 4th embodiment of FIG. 4G. In FIG. 4G and FIG. 4H, the optical element 412 includes a light blocking portion 420b and an anti-reflecting thin film 430. The light blocking portion 420b includes an object-side surface 424b, an image-side surface 425b and a connecting surface 426b. The object-side surface 424b is close to an object-side direction of the imaging lens assembly module 400, the image-side surface 425b is relative to the object-side surface 424b, and the connecting surface 426b connects the object-side surface 424b and the image-side surface 425b. Further, the connecting surface 426b is closer to the optical axis X than the object-side surface 424b and the image-side surface 425b to the optical axis X, and the anti-reflecting thin film 430 is at least disposed on the connecting surface 426b. Further, the anti-reflecting thin film 430 can be further extended to the image-side surface 425b.

In FIG. 4E and FIG. 4H, when a shortest distance between each of the light blocking portions 420a, 420b and the optical axis X is DO, the parameters can satisfy the conditions in Table 4 as follows.

TABLE 4
4th Embodiment

| | | | |
|---|---|---|---|
| DO (mm) | 2.72 | DO (mm) | 2.38 |
| (the light blocking | | (the light blocking | |
| portion 420a) | | portion 420b) | |

### 5th Embodiment

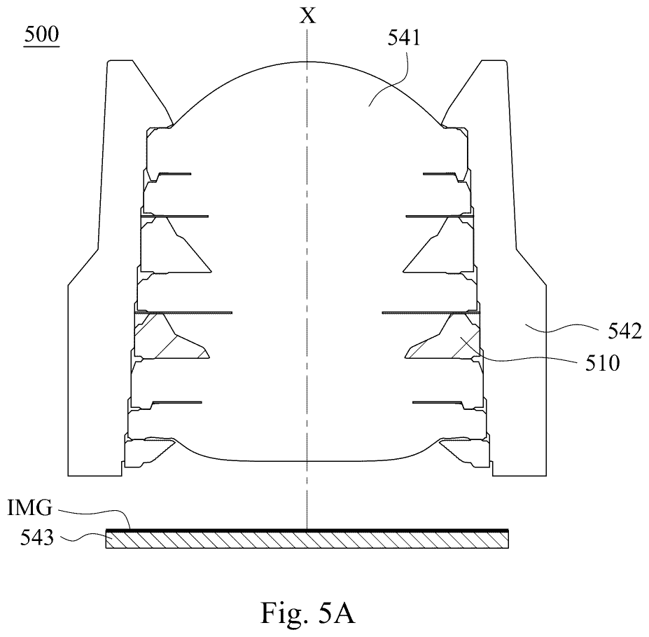

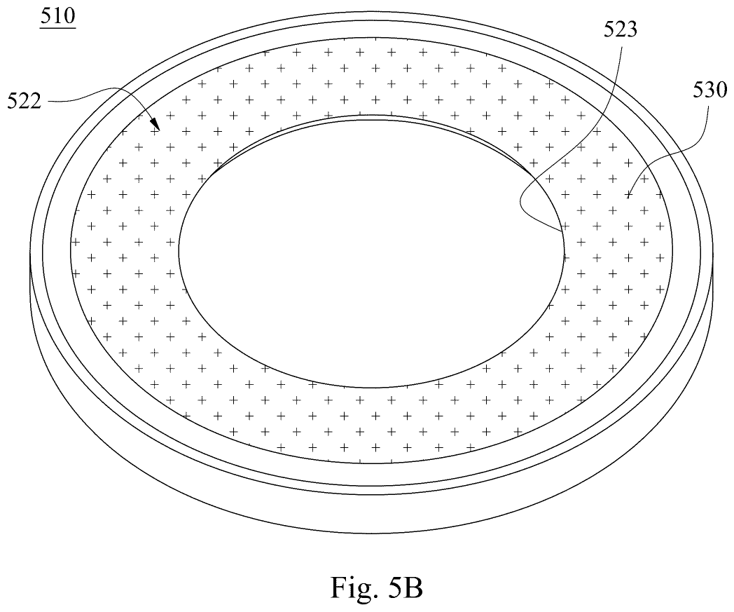

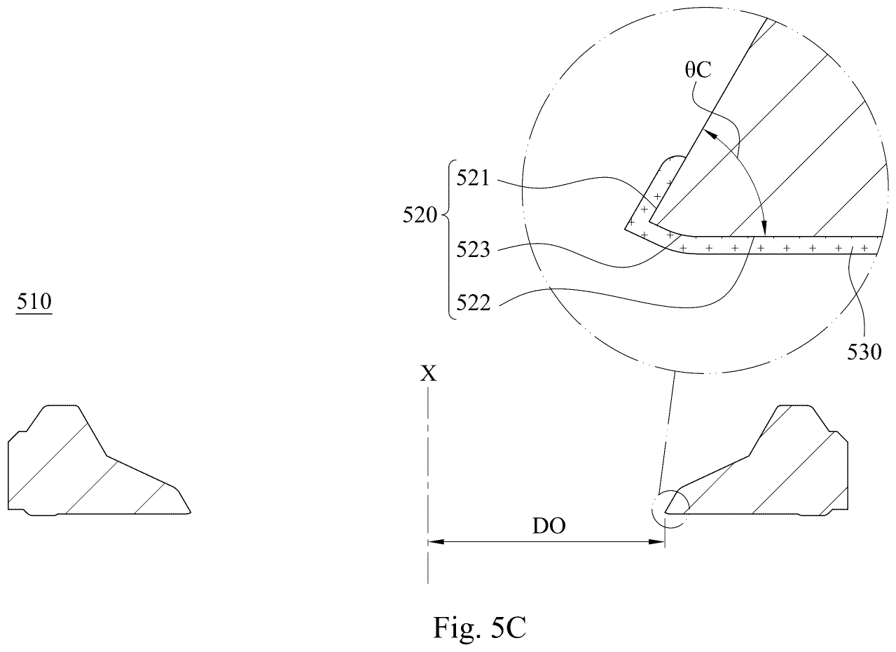

FIG. 5A is a schematic view of an imaging lens assembly module 500 according to the 5th embodiment of the present disclosure. In FIG. 5A, the imaging lens assembly module 500 defines an optical axis X, and includes an optical element 510, a lens element 541, a lens barrel 542 and an image sensor 543. The optical element 510 is a spacer, the lens barrel 542 is for accommodating the optical element 510 and the lens element 541. The image sensor 543 is disposed on an image surface IMG of the imaging lens assembly module 500.

FIG. 5B is a three-dimensional view of the optical element 510 according to the 5th embodiment of FIG. 5A. FIG. 5C is a schematic view of the optical element 510 according to the 5th embodiment of FIG. 5A. In FIG. 5B and FIG. 5C, the optical element 510 includes a light blocking portion 520 and an anti-reflecting thin film 530. The light blocking portion 520 is opaque, and the light blocking portion 520 is closer to the optical axis X than the other portion of the optical element 510 to the optical axis X. The anti-reflecting thin film 530 is disposed at least on a surface of the light blocking portion 520. The anti-reflecting thin film 530 incudes a nano structure layer and at least one intermediate layer, wherein the intermediate layer is disposed between the nano structure layer and the optical element 510. The nano structure layer has a plurality of ridge-like protrusions which extends non-directionally, wherein a bottom of each of the ridge-like protrusions is closer to the optical element 510 of a top of each of the ridge-like protrusions, each of the ridge-like protrusions tapers from the bottom to the top.

The nano structure layer is mainly made of Aluminium oxide. The nano structure layer includes the metallic doping agent, wherein the metallic doping agent is at least distributed inside of each of the ridge-like protrusions, the metallic doping agent is made of at least one of Titanium, Vanadium, Chromium, Titanium oxide, Vanadium oxide, Chromium oxide.

The light blocking portion 520 can include a first end surface 521 and a second end surface 522, wherein the first end surface 521 is tilted relative to the optical axis X, the second end surface 522 connects to the first end surface 521, wherein an folded angle 523 is formed between the first end surface 521 and the second end surface 522. Further, the folded angle 523 is closer to the optical axis X than the first end surface 521 and the second end surface 522 to the optical axis X, the anti-reflecting thin film 530 is disposed at least on the folded angle 523, wherein the folded angle 523 is a combination of an edged angle and a rounded angle, and the location of the anti-reflecting thin film 530 can be extended to the first end surface 521 and the second end surface 522.

In FIG. 5C, when a shortest distance between the light blocking portion 520 and the optical axis X is DO, the folded angle 523 is θC, the parameters can satisfy the conditions in Table 5 as follows.

TABLE 5
5th Embodiment

| | | | |
|---|---|---|---|
| DO (mm) | 1.55 | θC (degrees) | 60 |

<6th Embodiment>

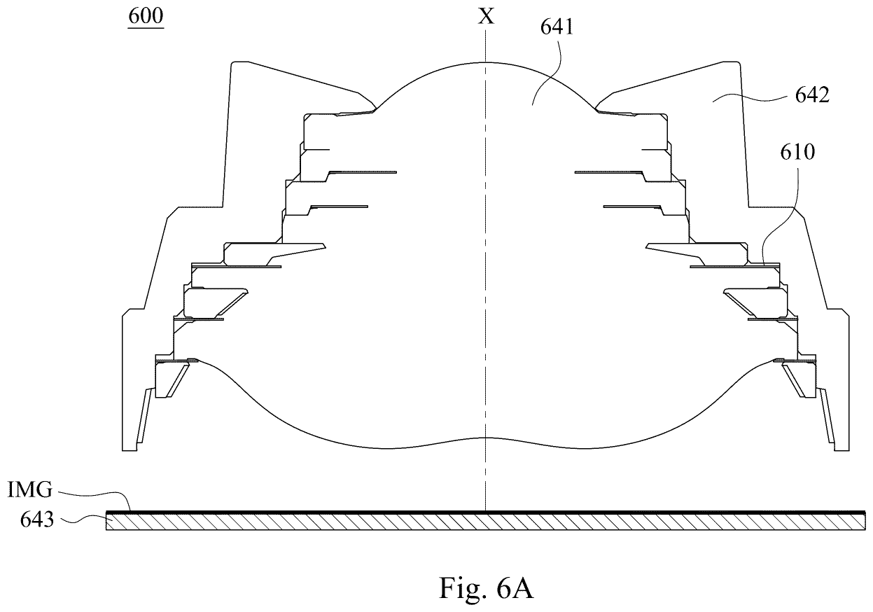

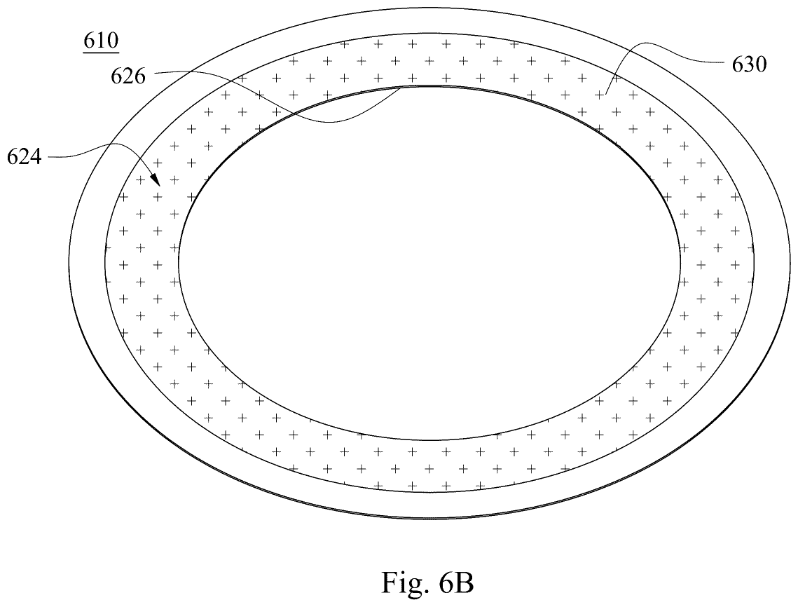

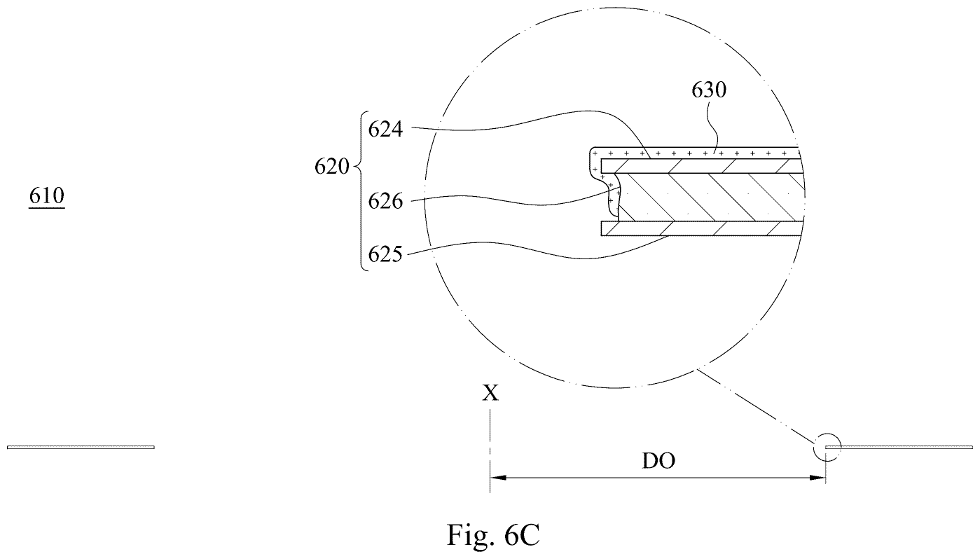

FIG. 6A is a schematic view of an imaging lens assembly module 600 according to the 6th embodiment of the present disclosure. In FIG. 6A, the imaging lens assembly module 600 defines an optical axis X, and includes an optical element 610, a lens element 641, a lens barrel 642 and an image sensor 643. The optical element 610 is a light blocking sheet, the lens barrel 642 is for accommodating the optical element 610 and the lens element 641. The image sensor 643 is disposed on an image surface IMG of the imaging lens assembly module 600.

FIG. 6B is a three-dimensional view of the optical element 610 according to the 6th embodiment of FIG. 6A. FIG. 6C is a schematic view of the optical element 610 according to the 6th embodiment of FIG. 6A. In FIG. 6B and FIG. 6C, the optical element 610 includes a light blocking portion 620 and an anti-reflecting thin film 630. The light blocking portion 620 is opaque, and the light blocking portion 620 is closer to the optical axis X than the other portion of the optical element 610 to the optical axis X. The anti-reflecting thin film 630 is disposed at least on a surface of the light blocking portion 620. The anti-reflecting thin film 630 incudes a nano structure layer and at least one intermediate layer, wherein the intermediate layer is disposed between the nano structure layer and the optical element 610. The nano structure layer has a plurality of ridge-like protrusions which extends non-directionally, wherein a bottom of each of the ridge-like protrusions is closer to the optical element 610 of a top of each of the ridge-like protrusions, each of the ridge-like protrusions tapers from the bottom to the top.

The nano structure layer is mainly made of Aluminium oxide. The nano structure layer includes the metallic doping agent, wherein the metallic doping agent is at least distributed inside of each of the ridge-like protrusions, the metallic doping agent is made of at least one of Titanium, Vanadium, Chromium, Titanium oxide, Vanadium oxide, Chromium oxide.

The light blocking portion 620 includes an object-side surface 624, an image-side surface 625 and a connecting surface 626. The object-side surface 624 is close to an object-side direction of the imaging lens assembly module 600, the image-side surface 625 is relative to the object-side surface 624, and the connecting surface 626 connects the object-side surface 624 and the image-side surface 625. Further, the connecting surface 626 is closer to the optical axis X than the object-side surface 624 and the image-side surface 625 to the optical axis X, and the anti-reflecting thin film 630 is at least disposed on the connecting surface 626. Further, the anti-reflecting thin film 630 can be further extended to the object-side surface 624.

In detail, the connecting surface 626 of the light blocking portion 620 can be additionally processed to make the connecting surface 626 uneven, so that the reflection of stray light on the connecting surface 626 can be avoided.

In FIG. 6C, when a shortest distance between the light blocking portion 620 and the optical axis X is DO, the parameter can satisfy the condition in Table 6 as follows.

TABLE 6
6th Embodiment

| | |
|---|---|
| DO (mm) | 2.82 |

### 7th Embodiment

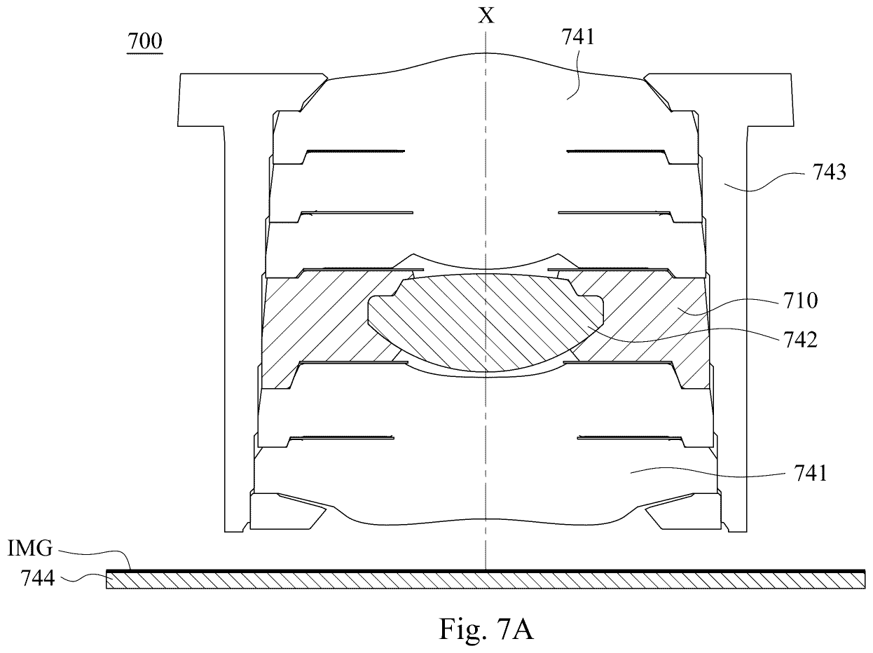

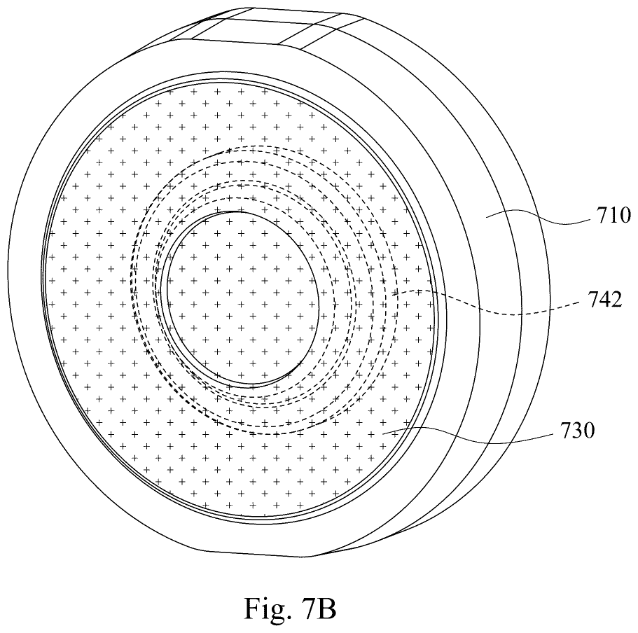

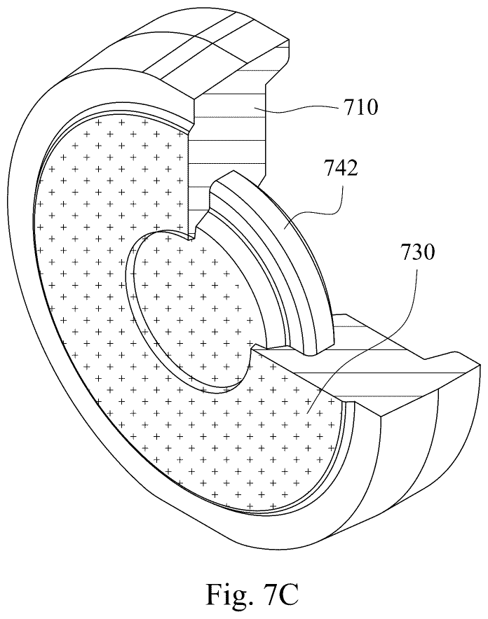

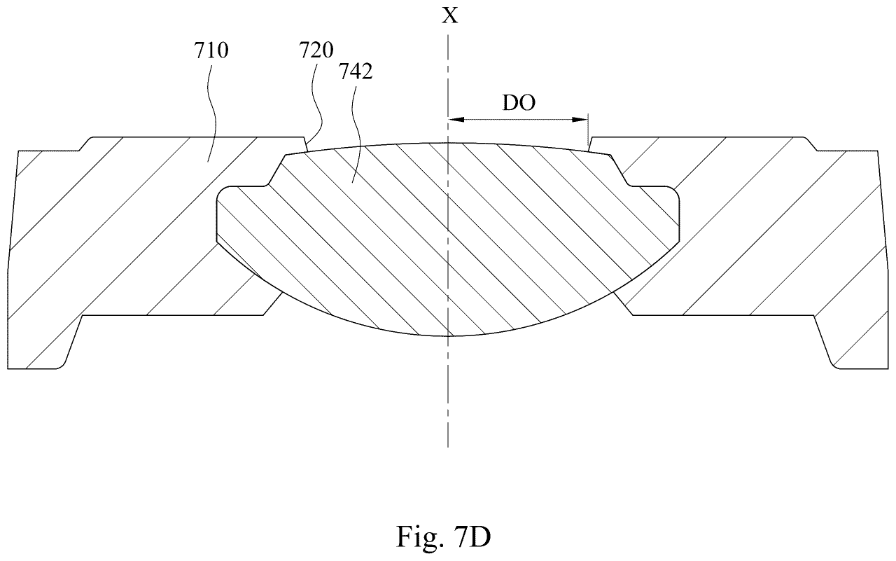

FIG. 7A is a schematic view of an imaging lens assembly module 700 according to the 7th embodiment of the present disclosure. In FIG. 7A, the imaging lens assembly module 700 defines an optical axis X, and includes an optical element 710, lens elements 741, 742, a lens barrel 743 and an image sensor 744. The optical element 710 is a spacer, the lens barrel 743 is for accommodating the optical element 710 and the lens elements 741, 742. The image sensor 744 is disposed on an image surface IMG of the imaging lens assembly module 700.

FIG. 7B is a three-dimensional view of the optical element 710 and the lens element 742 according to the 7th embodiment of FIG. 7A. FIG. 7C is a partial cross-sectional view of the optical element 710 and the lens element 742 according to the 7th embodiment of FIG. 7B. FIG. 7D is a schematic view of the optical element 710 and the lens element 742 according to the 7th embodiment of FIG. 7A. In FIG. 7A to FIG. 7D, the lens element 742 is connected to the optical element 710 by an insert molding method so as to form a molded glass lens element.

In FIG. 7B to FIG. 7D, the optical element 710 includes a light blocking portion 720 and an anti-reflecting thin film 730. The light blocking portion 720 is opaque, and the light blocking portion 720 is closer to the optical axis X than the other portion of the optical element 710 to the optical axis X. The anti-reflecting thin film 730 is disposed at least on a surface of the light blocking portion 720. The anti-reflecting thin film 730 incudes a nano structure layer and at least one intermediate layer, wherein the intermediate layer is disposed between the nano structure layer and the optical element 710. The nano structure layer has a plurality of ridge-like protrusions which extends non-directionally, wherein a bottom of each of the ridge-like protrusions is closer to the optical element 710 of a top of each of the ridge-like protrusions, each of the ridge-like protrusions tapers from the bottom to the top.

The nano structure layer is mainly made of Aluminium oxide. The nano structure layer includes the metallic doping agent, wherein the metallic doping agent is at least distributed inside of each of the ridge-like protrusions, the metallic doping agent is made of at least one of Titanium, Vanadium, Chromium, Titanium oxide, Vanadium oxide, Chromium oxide.

In FIG. 7B, the anti-reflecting thin film 730 can be extended to the lens element 742.

In FIG. 7D, when a shortest distance between the light blocking portion 720 and the optical axis X is DO, the parameter can satisfy the condition in Table 7 as follows.

TABLE 7
7th Embodiment

| | |
|---|---|
| DO (mm) | 0.94 |

### 8th Embodiment

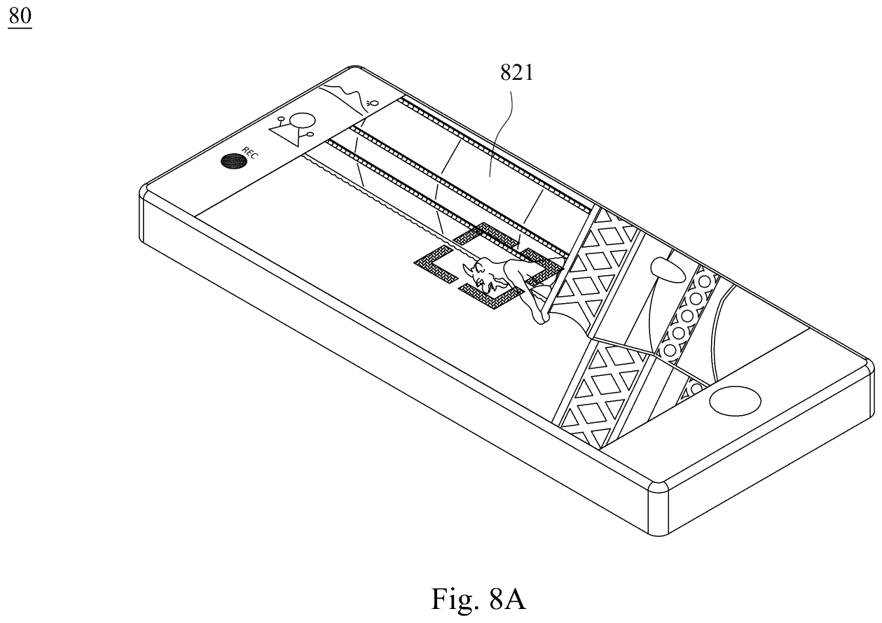

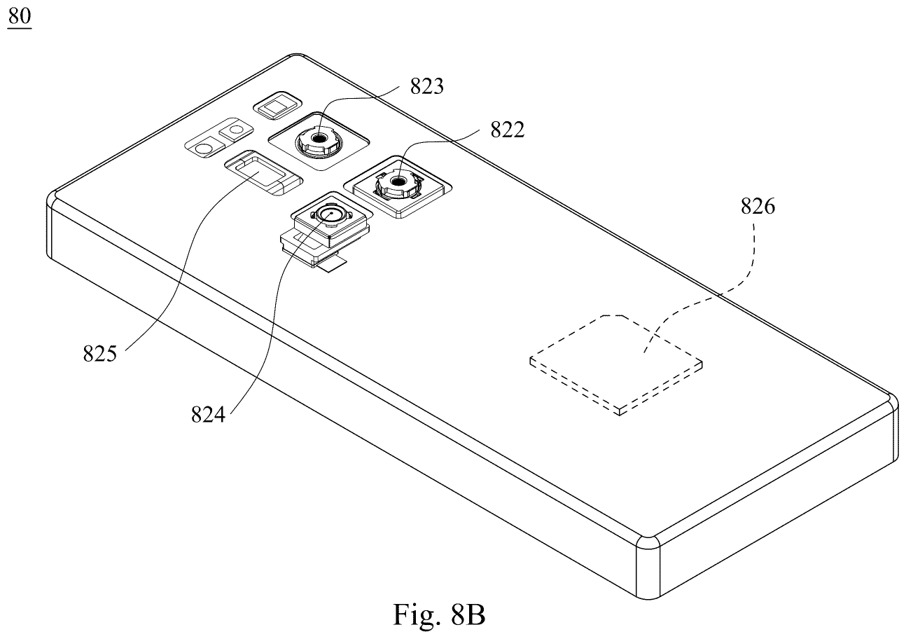

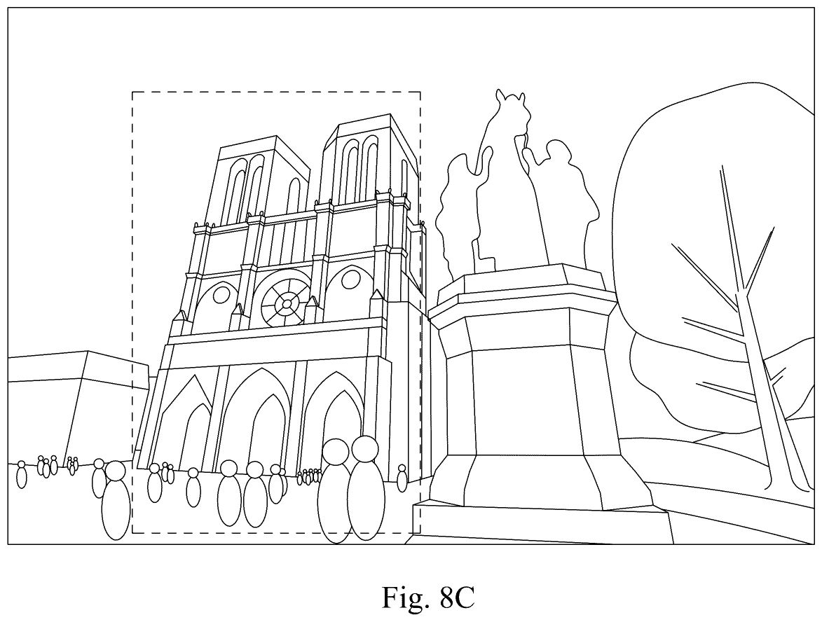

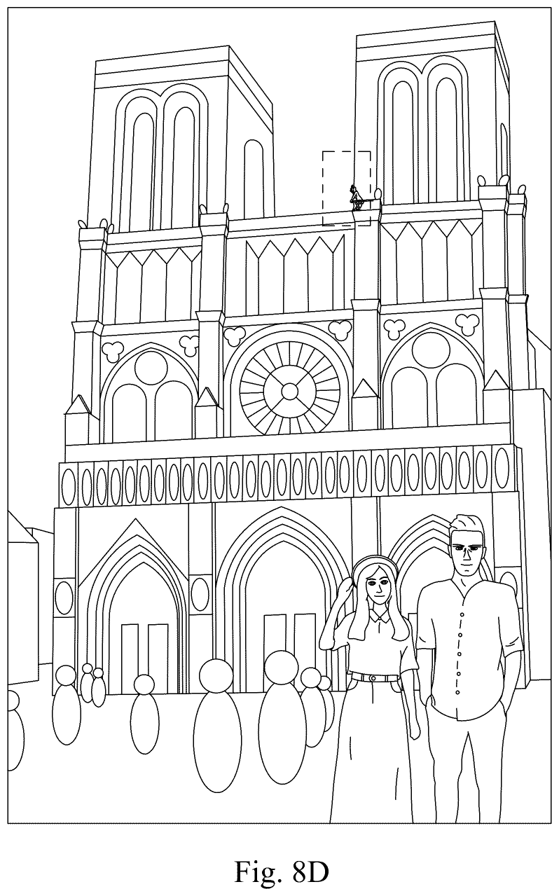

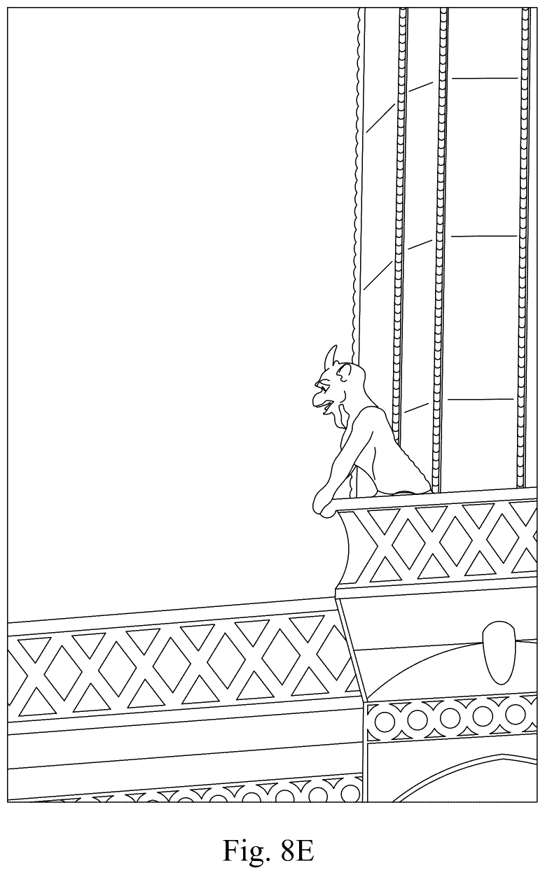

FIG. 8A is a schematic view of an electronic device 80 according to the 8th embodiment of the present disclosure. FIG. 8B is another schematic view of the electronic device 80 according to the 8th embodiment in FIG. 8A. In FIG. 8A and FIG. 8B, the electronic device 80 is a smart phone, and includes a user interface 821 and a plurality of imaging lens assembly modules. Further, the imaging lens assembly modules are an ultra-wide angle imaging lens assembly module 822, a high-pixel imaging lens assembly module 823 and telephoto imaging lens assembly modules 824, 825, and the user interface 821 is a touch screen, which is not limited thereto. Specifically, the ultra-wide angle imaging lens assembly module 822 can be the imaging lens assembly module 100 according to the aforementioned 1st embodiment, the high-pixel imaging lens assembly module 823 can be the imaging lens assembly module 200 according to the aforementioned 2nd embodiment, the telephoto imaging lens assembly module 824 can be the imaging lens assembly module 300 according to the aforementioned 3rd embodiment, the telephoto imaging lens assembly module 825 can be the imaging lens assembly module 400 according to the aforementioned 4th embodiment, and the present disclosure will not be limited thereto.

Furthermore, users enter a shooting mode via the user interface 821, wherein the user interface 821 is for displaying the scene, and the shooting angle can be manually adjusted to switch the different imaging lens assembly modules. At this moment, the imaging light is gathered on the image sensor via the imaging lens assembly module, and an electronic signal about an image is output to an image signal processor (ISP) 826.

In FIG. 8A and FIG. 8B, to meet a specification of the electronic device 80, the electronic device 80 can further include an optical anti-shake mechanism (not shown in drawings). Furthermore, the electronic device 80 can further include at least one focusing assisting module (not shown in drawings) and at least one sensing element (not shown in drawings). The focusing assisting module can be a flash module for compensating a color temperature, an infrared distance measurement component, a laser focus module, etc. The sensing element can have functions for sensing physical momentum and kinetic energy, such as an accelerator, a gyroscope, a Hall Effect Element, to sense shaking or jitters applied by hands of the user or external environments. Accordingly, the imaging lens assembly module of the electronic device 80 equipped with an auto-focusing mechanism and the optical anti-shake mechanism can be enhanced to achieve the superior image quality. Furthermore, the electronic device 80 according to the present disclosure can have a capturing function with multiple modes, such as taking optimized selfies, high dynamic range (HDR) under a low light condition, 4K resolution recording, etc. Furthermore, the users can visually see a captured image of the camera through the user interface 821 and manually operate the view finding range on the user interface 821 to achieve the auto-focus function of what you see is what you get.

Moreover, the imaging lens assembly modules, the optical anti-shake mechanism, the sensing element and the focusing assisting module can be disposed on a flexible printed circuit board (FPC) (not shown in drawings) and electrically connected to the associated components, such as the image signal processor 826, via a connector (not shown in drawings) to perform a capturing process. Since the current electronic devices, such as smart phones, have a tendency of being compact, the way of firstly disposing the imaging lens assembly module and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the imaging lens assembly module can also be controlled more flexibly via the touch screen of the electronic device.

According to the 8th embodiment, the electronic device 80 can include a plurality of sensing elements and a plurality of focusing assisting modules. The sensing elements and the focusing assisting modules are disposed on the flexible printed circuit board and at least one other flexible printed circuit board (not shown in drawings) and electrically connected to the associated components, such as the image signal processor 826, via corresponding connectors to perform the capturing process. In other examples (not shown in drawings), the sensing elements and the focusing assisting modules can also be disposed on the main board of the electronic device or carrier boards of other types according to requirements of the mechanical design and the circuit layout.

Furthermore, the electronic device 80 can further include, but not be limited to, a display, a control unit, a storage unit, a random access memory (RAM), a read-only memory (ROM), or the combination thereof.

FIG. 8C is a schematic view of an image captured by the electronic device 80 according to the 8th embodiment in FIG. 8A. In FIG. 8C, the larger range of the image can be captured via the ultra-wide angle imaging lens assembly module 822, and the ultra-wide angle imaging lens assembly module 822 can have the function of accommodating more wide range of the scene.

FIG. 8D is another schematic view of an image captured by the electronic device 80 according to the 8th embodiment in FIG. 8A. In FIG. 8D, the image of the certain range with the high resolution can be captured via the high-pixel imaging lens assembly module 823, and the high-pixel imaging lens assembly module 823 has the function of the high resolution and the low deformation.

FIG. 8E is further another schematic view of an image captured by the electronic device 80 according to the 8th embodiment in FIG. 8A. In FIG. 8E, the telephoto imaging lens assembly modules 824, 825 have the enlarging function of the high magnification, and the distant image can be captured and enlarged with high magnification via the telephoto imaging lens assembly modules 824, 825.

In FIG. 8C to FIG. 8E, the zooming function can be obtained via the electronic device 80, when the scene is captured via the camera module with different focal lengths cooperated with the function of image processing.

### 9th Embodiment

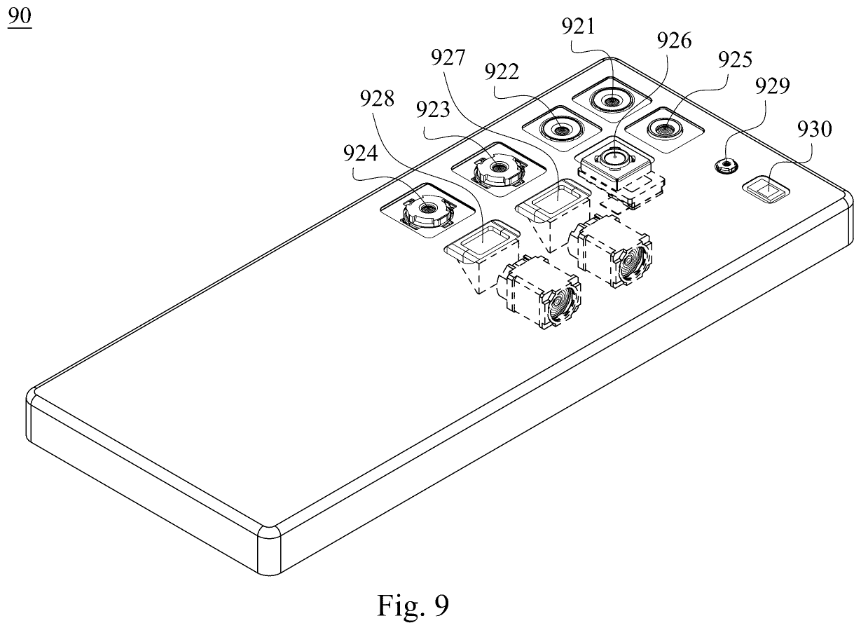

FIG. 9 is a schematic view of an electronic device 90 according to the 9th embodiment of the present disclosure. In FIG. 9, the electronic device 90 is a smart phone, and includes a plurality of imaging lens assembly modules. Furthermore, the imaging lens assembly modules are ultra-wide angle camera modules 921, 922, wide angle camera modules 923, 924, telephoto camera modules 925, 926, 927, 928, and a Time-Of-Flight (TOF) module 929. The TOF module 929 can be another type of the imaging lens assembly module, and the disposition is not limited thereto.

In detail, the ultra-wide angle imaging lens assembly module 921 can be the imaging lens assembly module 100 according to the aforementioned 1st embodiment, the ultra-wide angle imaging lens assembly module 922 can be the imaging lens assembly module 700 according to the aforementioned 7th embodiment, the wide angle camera module 923 can be the imaging lens assembly module 200 according to the aforementioned 2nd embodiment, the wide angle camera module 924 can be the imaging lens assembly module 600 according to the aforementioned 6th embodiment, the telephoto camera module 925 can be the imaging lens assembly module 500 according to the aforementioned 5th embodiment, the telephoto camera module 926 can be the imaging lens assembly module 300 according to the aforementioned 3rd embodiment, the telephoto camera module 927 can be the imaging lens assembly module 400 according to the aforementioned 4th embodiment.

Further, the telephoto camera modules 927, 928 are configured to fold the light path, but the present disclosure is not limited thereto.

To meet a specification of the electronic device 90, the electronic device 90 can further include an optical anti-shake mechanism (not shown in drawings). Furthermore, the electronic device 90 can further include at least one focusing assisting module (not shown in drawings) and at least one sensing element (not shown in drawings). The focusing assisting module can be a flash module 930 for compensating a color temperature, an infrared distance measurement component, a laser focus module, etc. The sensing element can have functions for sensing physical momentum and kinetic energy, such as an accelerator, a gyroscope, a Hall Effect Element, to sense shaking or jitters applied by hands of the user or external environments. Accordingly, the camera module of the electronic device 90 equipped with an auto-focusing mechanism and the optical anti-shake mechanism can be enhanced to achieve the superior image quality. Furthermore, the electronic device 90 according to the present disclosure can have a capturing function with multiple modes, such as taking optimized selfies, High Dynamic Range (HDR) under a low light condition, 4K Resolution recording, etc.

Further, all of other structures and dispositions according to the 9th embodiment are the same as the structures and the dispositions according to the 8th embodiment, and will not be described again herein.

### 10th Embodiment

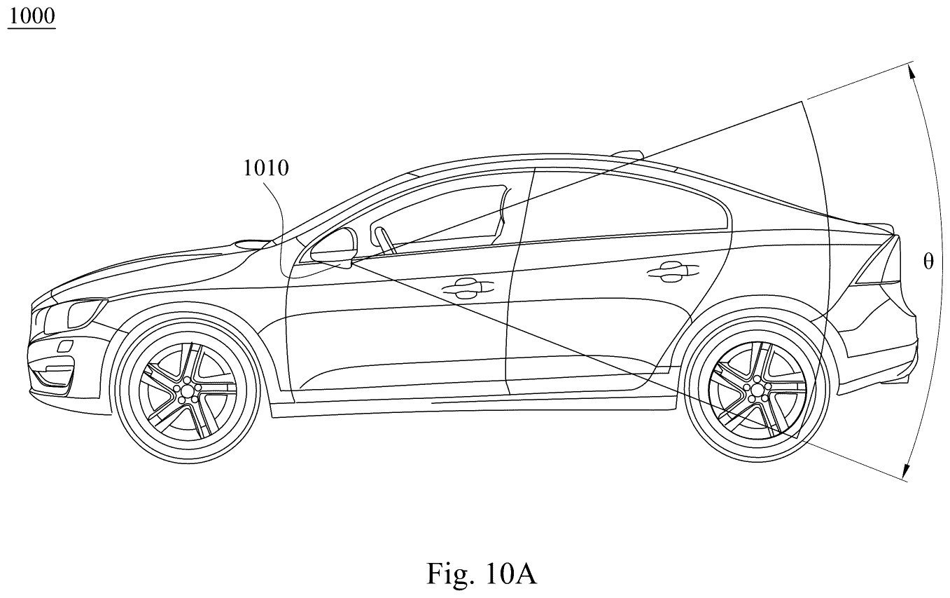

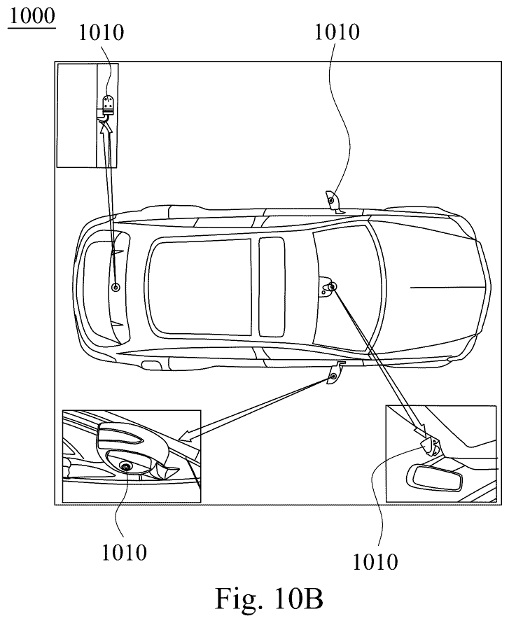

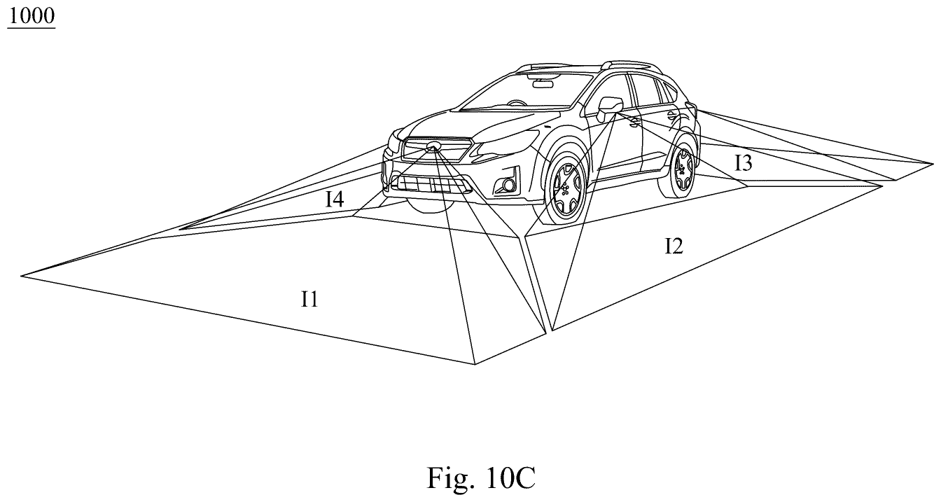

FIG. 10A is a schematic view of imaging lens assembly modules 1010 applied to a vehicle device 1000 according to the 10th embodiment of the present disclosure. FIG. 10B is another schematic view of the imaging lens assembly modules 1010 arranged on the vehicle device 1000 according to the 10th embodiment in FIG. 10A. FIG. 10C is further another schematic view of the imaging lens assembly modules 1010 arranged on the vehicle device 1000 according to the 10th embodiment in FIG. 10A. In FIG. 10A to FIG. 10C, the vehicle device 1000 includes the imaging lens assembly modules 1010. In the 10th embodiment, a number of the imaging lens assembly modules 1010 is six, which are automotive imaging lens assembly modules. Each of the imaging lens assembly modules 1010 can be the imaging lens assembly module according to any one of the aforementioned 1st embodiment to 7th embodiment, but the present disclosure is not limited thereto.

In FIG. 10A to FIG. 10B, the imaging lens assembly modules 1010 are located under two rear view mirrors on the left side and the right side, respectively, which is for capturing image information from a field of view θ. Specifically, the field of view θ can satisfy the following condition: 40 degrees<θ<90 degrees. Hence, the image information in the region of two lanes on the left side and the right side can be captured.

In FIG. 10B and FIG. 10C, another two of the imaging lens assembly modules 1010 can be disposed in an inner space of the vehicle device 1000, so that the traffic information outside the vehicle can be obtained, such as 11, 12, 13, 14, but not limited thereto. Specifically, the aforementioned two imaging lens assembly modules 1010 can be disposed near a rear view mirror in the vehicle device 1000 and near a rear window, respectively. Further, the imaging lens assembly modules 1010 can also be disposed on non-mirror surfaces of two rear view mirrors on left side and right side of the vehicle device 1000, respectively, but not limited thereto.

Further another two of the imaging lens assembly modules 1010 can be disposed at the front end and the rear end of the vehicle device 1000. Furthermore, the traffic information outside the vehicle can be identified helpfully by the arrangement of the imaging lens assembly modules 1010 disposed at the front end, the rear end and below the left and right rear view mirrors of the vehicle device 1000. Therefore, the angle of view can be provided widely to decrease the blind spot, which is favorable for improving driving safety. Furthermore, it is favorable for identifying the external space information out of the vehicle device 1000 by arranging the imaging lens assembly modules 1010 around the vehicle device 1000 to achieve the function of autopilot.

The foregoing description, for purpose of explanation, has been described with reference to specific embodiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens assembly module, defining an optical axis, and comprising:
an optical element, comprising:
a light blocking portion being opaque, and the light blocking portion being closer to the optical axis than the other portion of the optical element to the optical axis; and
an anti-reflecting thin film disposed at least on a surface of the light blocking portion, and the anti-reflecting thin film comprising:
a nano structure layer having a plurality of ridge-like protrusions which extends non-directionally, wherein a bottom of each of the ridge-like protrusions is closer to the optical element of a top of each of the ridge-like protrusions, each of the ridge-like protrusions tapers from the bottom to the top, and an average structure height of the ridge-like protrusions is greater than 108 nm and smaller than 368 nm; and
at least one intermediate layer disposed between the nano structure layer and the optical element;
wherein the nano structure layer is mainly made of Aluminium oxide, and the nano structure layer comprises a metallic doping agent, wherein the metallic doping agent is at least distributed inside of each of the ridge-like protrusions, the metallic doping agent comprises at least one of Titanium, Vanadium, Chromium, Titanium oxide, Vanadium oxide, Chromium oxide.

2. The imaging lens assembly module of claim 1, wherein a shortest distance between the light blocking portion and the optical axis is DO, and the following condition is satisfied:
0.01 mm≤DO≤6.8 mm.

3. The imaging lens assembly module of claim 2, wherein the light blocking portion comprises:
an object-side surface being close to an object-side direction of the imaging lens assembly module;
an image-side surface relative to the object-side surface; and
a connecting surface connecting the object-side surface and the image-side surface;
wherein the connecting surface is closer to the optical axis than the object-side surface and the image-side surface to the optical axis, and the anti-reflecting thin film is disposed at least on the connecting surface.

4. The imaging lens assembly module of claim 3, wherein the anti-reflecting thin film is further disposed on the object-side surface or the image-side surface.

5. The imaging lens assembly module of claim 2, wherein the light blocking portion comprises:
a first end surface being tilted relative to the optical axis; and
a second end surface connecting to the first end surface, wherein an folded angle is formed between the first end surface and the second end surface;
wherein the folded angle is closer to the optical axis than the first end surface and the second end surface to the optical axis, the anti-reflecting thin film is disposed at least on the folded angle, the folded angle is θC, and the following condition is satisfied:
9 degrees<θC<162 degrees.

6. The imaging lens assembly module of claim 5, wherein the anti-reflecting thin film is further disposed on the first end surface and the second end surface.

7. The imaging lens assembly module of claim 1, wherein the at least one intermediate layer is mainly made of Silicon dioxide.

8. The imaging lens assembly module of claim 1, wherein a main component of the at least one intermediate layer is the same with a part of components of the nano structure layer.

9. The imaging lens assembly module of claim 1, wherein the metallic doping agent is further distributed on one surface of each of the ridge-like protrusions.

10. The imaging lens assembly module of claim 9, wherein the metallic doping agent distributed inside each of the ridge-like protrusions is tapered away from the optical element.

11. The imaging lens assembly module of claim 9, wherein a coverage thickness of the metallic doping agent on the surface of each of the ridge-like protrusions is TM, and the following condition is satisfied:
1 nm≤TM≤40 nm.

12. The imaging lens assembly module of claim 11, wherein the coverage thickness of the metallic doping agent on the surface of each of the ridge-like protrusions is TM, and the following condition is satisfied:
1 nm≤TM≤30 nm.

13. The imaging lens assembly module of claim 1, wherein the metallic doping agent is Titanium or Titanium oxide.

14. The imaging lens assembly module of claim 1, wherein the anti-reflecting thin film further comprises:
a dark layer disposed between the at least one intermediate layer and the optical element, which is for providing a dark appearance of the optical element.

15. An electronic device, comprising:
the imaging lens assembly module of claim 1.
